(19) United States
(12) Patent Application Publication
(10) Pub. No.: US 2019/0035569 A1
(43) Pub. Date: Jan. 31, 2019

(54) Continuously Powered Load Switch Lock

(71) Applicant: Laurence P. Sadwick, Salt Lake City, UT (US)

(72) Inventor: Laurence P. Sadwick, Salt Lake City, UT (US)

(21) Appl. No.: 16/072,177

(22) PCT Filed: Jan. 23, 2017
(86) PCT No.: PCT/US17/14624

§ 371 Date: Jul. 23, 2018

Related U.S. Application Data
(60) Provisional application No. 62/286,332, filed on Jan. 23, 2016.

(51) Int. Cl. H01H 9/28; H05B 37/02; H05B 33/08

(52) U.S. Cl. CPC H01H 9/287; H05B 37/0272; H05B 33/0815; H05B 33/0863; H05B 33/0845; H05B 33/0869

(57) ABSTRACT

An apparatus for supplying power includes a power input, a switch connected to the power input, a load configured to draw power from the power input through the switch, and a switch lock configured to prevent the switch from disconnecting the load from the power input.

### CROSS REFERENCE TO RELATED APPLICATION

The present application claims priority to U.S. Provisional Patent Application No. 62/286,332 entitled “Lighting and Control Systems”, and filed on Jan. 23, 2016, the entirety of which is incorporated herein by reference for all purposes.

### BACKGROUND

Solid state lighting systems are increasingly used to replace older technology lighting such as incandescent bulbs, fluorescent and high intensity discharge (HID) lamps, etc. Such solid state lighting systems can be much more energy efficient than older technology lighting, and can be cooler, safer, can avoid initial dimness suffered by some fluorescent lighting, etc. Some solid state lighting can also be highly controllable and customizable, for example supporting multiple colors, programmable settings, etc. However, when powered through a traditional light switch, power is cut to control systems and processors in the light source including but not limited to solid state lighting systems if the switch is turned off. This can disable features such as the ability to remotely turn on a solid state light, or to request status information from a solid state light. Such a disadvantage can apply equally to other types of loads that can be connected to a traditional light switch or power switch.

Examples of such traditional switches 100, 110 are depicted in FIGS. 1 and 2. For example, a typical light switch 102 is depicted in FIG. 1, covered by a cover plate 104 held on by screws 106, 108. A rocker style decorative light switch 112 is depicted in FIG. 2, covered by a cover plate 114 held on by screws 116, 118. Generally, a load such as one or more lights are wired to an AC line through such a switch, with at least one conductor of the wiring (e.g., the “hot”, “live”, or powered conductor) passing through the switch. As a result, when the switch is turned off, no power reaches the load with such traditional wiring. Without rewiring the building or providing another source of power to the load to power it when the switch is off, the load is unpowered and is not functional when the switch is off. Even if the communications electronics is powered by, for example, but not limited to, a battery or alternative energy sources including but not limited to energy harvesting, in general, unless the battery or energy/power source is of a large number of amp-hours or other units of energy or power, the battery or other source of electricity will ultimately drain and need to be replenished or replaced. For example, an emergency light source with a battery to provide emergency power cannot last forever and often only lasts minutes to at most a few hours.

### SUMMARY

The present invention provides a switch lock that prevents a switch from being turned off, enabling smart solid state lighting or other types of loads to remain powered. This enables control and processing circuitry in the light or other load to remain functional, for example even when the light itself is turned off by the control and processing circuitry via a remote control, schedule, in response to sensor input or other events, etc.

This summary provides only a general outline of some particular embodiments. Many other objects, features, advantages and other embodiments will become more fully apparent from the following detailed description. Nothing in this document should be viewed as or considered to be limiting in any way or form.

### BRIEF DESCRIPTION OF THE FIGURES

A further understanding of the various embodiments of the present invention may be realized by reference to the Figures which are described in remaining portions of the specification. In the Figures, like reference numerals may be used throughout several drawings to refer to similar components.

FIG. 1 is an illustration of a prior art light switch.

FIG. 2 is an illustration of a prior art rocker-style light switch.

FIG. 3 is a perspective view of a light switch with a switch lock in accordance with some embodiments of the invention.

FIG. 4 is a side view of the light switch with switch lock of FIG. 3 in accordance with some embodiments of the invention.

FIG. 5 is a side view of a light switch with a switch lock, mounted with screws into threaded cover plate screw holes, in accordance with some embodiments of the invention.

FIG. 6 is a side view of a light switch with a switch lock, mounted with adhesive strips, in accordance with some embodiments of the invention.

FIG. 7 is a front view of a light switch with an oval switch lock over a light switch and cover plate in accordance with some embodiments of the invention.

FIG. 8 is a front view of an oval switch lock with user interface elements over a light switch and cover plate in accordance with some embodiments of the invention.

FIG. 9 is a front view of a light switch with a rectangular switch lock over a light switch and cover plate in accordance with some embodiments of the invention.

FIG. 10 is a side view of a light switch with a rectangular switch lock over a light switch, mounted by adhesive strips to a light switch cover plate in accordance with some embodiments of the invention.

FIG. 11 is a side view of a light switch with a rectangular switch lock over a light switch, mounted in place of a cover plate by screws into threaded holes in the light switch, in accordance with some embodiments of the invention.

FIG. 12 is a front view of a rectangular switch lock with user interface elements over a light switch and cover plate in accordance with some embodiments of the invention.

FIG. 13 is a side view of a light switch with a rectangular switch lock over a light switch, mounted by adhesive strips to a light switch cover plate, with user interface elements and electronic circuits in accordance with some embodiments of the invention.

FIG. 14 is a front view of a rectangular switch lock over a rocker style light switch in accordance with some embodiments of the invention.

FIG. 15 is a front view of a rectangular switch lock over a slider light switch/dimmer and a rocker switch in accordance with some embodiments of the invention.

FIG. 16 is a front view of a rectangular switch lock over multiple light switches in accordance with some embodiments of the invention.

FIG. 17 is a perspective view of a rotating dimmer switch with a switch lock behind it preventing the rotating dimmer switch from being depressed to turn it off in accordance with some embodiments of the invention.

FIG. 18 is a side view of the rotating dimmer switch and switch lock of FIG. 17.

FIG. 19 depicts a block diagram of a smart lighting system with a light switch and switch lock in accordance with some embodiments of the invention.

FIG. 20 depicts a block diagram of a continuously powered smart load with a light switch and switch lock with user interface in accordance with some embodiments of the invention.

FIG. 21 depicts a block diagram of a continuously powered smart load with a light switch and switch lock with configuration circuit in accordance with some embodiments of the invention.

FIG. 22 depicts a block diagram of a continuously powered smart load with a light switch and switch lock with configuration circuit and energy harvester in accordance with some embodiments of the invention.

FIG. 23 depicts a block diagram of a continuously powered smart load with a light switch and switch lock with infrared (IR)/radio frequency (RF) converter or other wireless technology in accordance with some embodiments of the invention.

FIG. 24 depicts a block diagram of a continuously powered smart load with a light switch and switch lock with configuration circuit and voice recognition circuit in accordance with some embodiments of the invention.

FIG. 25 depicts a block diagram of various non-limiting interfaces that can communicate with circuits in a switch lock in accordance with some embodiments of the invention.

FIG. 26 depicts a switch lock and various non-limiting example systems that can be used with the switch lock in accordance with some embodiments of the invention.

FIG. 27 depicts an in-socket solid state lighting-compatible controller/dimmer that can be used with a switch lock in accordance with some embodiments of the invention.

FIG. 28 depicts an in-socket solid state lighting-compatible controller/dimmer and solid state light that can be used with a switch lock in accordance with some embodiments of the invention.

FIG. 29 depicts a solid state light mounted in an in-socket solid state lighting-compatible controller/dimmer that can be used with a switch lock in accordance with some embodiments of the invention.

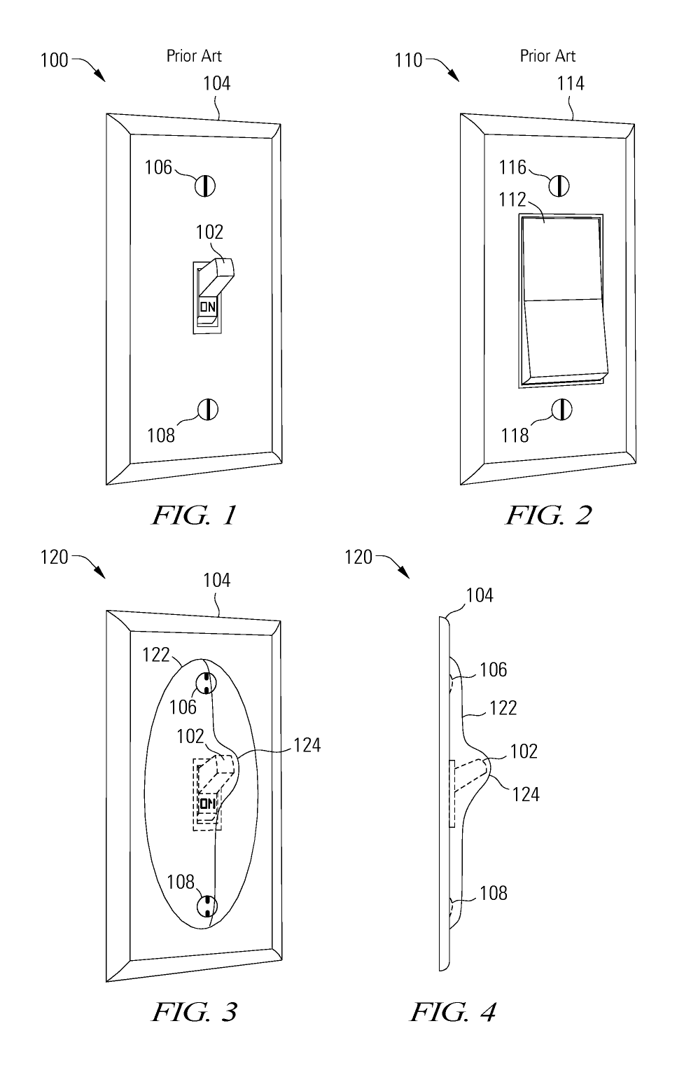

### DETAILED DESCRIPTION OF THE INVENTION

Various embodiments are disclosed herein of a switch lock that enables a load to be continuously powered without being turned off by a switch. In some embodiments, the switch lock covers or shields a switch to prevent its actuation or turning off. In some other embodiments, the switch lock physically prevents a switch from being turned off by blocking or limiting its movement. In some embodiments of the present invention the lock may be disabled including temporarily or longer to allow for example but not limited to manual and/or override, etc. control. For example, in some embodiments, the switch lock can be opened to provide access to a switch, or can include an automatic actuator to turn the switch on and off by a motor, solenoid or any other suitable device, under manual control by a user interface on the lock switch, or under remote control, or automated control by a processing system, whether internal or external.

In some embodiments, a switch lock includes a user interface, which can include input and/or output interface elements. Such a user interface can be coupled with the load being powered through the switch and/or other loads or systems. For example, if a legacy lighting system such as an incandescent bulb or fluorescent tube is replaced with a solid state lighting system, powered through an existing light switch, the switch lock prevents power from being turned off to the solid state lighting system. This enables control circuits in the solid state lighting system to remain powered, allowing the control circuits to control the solid state lighting system, for example but not limited to turning on and off the solid state light.

The user interface in the switch lock can, for example, be adapted to control the solid state lighting system. On/off commands and other commands can be entered via the user interface in the switch lock and can be transmitted to the control circuits in the solid state lighting system using wireless and/or wired communications. Display lights, indicators, panels etc. can be provided on the switch lock to indicate the status of the solid state lighting system.

It is important to note that the switch lock is not limited to use with any particular type of switch, or with any particular load or loads. On/off switches, rocker switches, buttons, knobs, dials, touch panels, etc. can be locked by the switch lock, with any kind of load for which supply power should not be disrupted, whether entirely or in part. In addition, for example, but not limited to, the shape, form, form factor, size, etc., can be of generally any type. For example, embodiments of the present invention can fit exactly over the existing switch or dimmer, etc. replicating the same shape or it can provide a different shape—one that is, for example but not limited to, more curvy, more boxy. More rectangular, more right angular, less boxy, angles that are not right angles, etc.

The switch lock enables a light or other load to be replaced by a continuously powered light or other load, without replacing, rewiring or altering existing switches in the power supply path to the load. Various embodiments of the switch lock can replace the wall switch or dimmer with a smart switch or cover up the wall switch or dimmer with, for example, a shapely or boxy cover, cover plate, etc. that attaches, screws in, overlays, etc., to the existing wall switch or dimmer, etc. Such a cover can be decorative or functional, etc., combinations of these, etc. Such a switch lock can have wireless (e.g., Bluetooth, WiFi, ZigBee, Zwave, IEEE 802, etc.), wired (e.g., analog, 0 to 10 V, 0 to 3 V, etc.), digital, PWM, DMX, DALI, UART, SPI, I2C, RS232, RS485, other serial, parallel, etc., powerline communications (PLC), etc., combinations of these, etc. The switch lock can contain circuits, such as, but not limited to, user interface circuits, and can be powered by solar cells, photovoltaic(s), etc., which could also be flexible, transparent, designed to match the background (color(s), pattern(s), etc.), designed to be a tape, include or incorporate (etc.) but not limited to an adhesive, be part of wall paper, paint, etc., panel(s), adhere to, attach to, adhesion of any type, means or form, paste, staple, screw, rivet, magnet, friction, etc., combinations of these, combinations of adhesives and other attachment methods, etc. The switch lock can include battery power, rechargeable or otherwise, and can also or alternatively use other energy harvesting including, but not limited to, mechanical, electrical, acoustic, RF, wireless power transfer, vibrational, optical, etc., combinations of these, etc.

Such a switch lock or cover can also include ‘buttons’ and associated circuitry that can perform the previous functions of the switch, dimmer, etc. including but not limited to dimming, turning the light switch or other switch or switches on or off, having motion sensors, light sensor, daylight harvesting, alarms, panic button(s), other sensors and detectors, other functions, other IOT, etc., combinations of these, etc.

Turning to FIG. 3, a locked light switch 120 is depicted in perspective view in accordance with some embodiments of the invention. A light switch 124 is covered by a switch lock 122 that, in this example embodiment, is generally oval with a protrusion 124 over the switch 124, covering the switch 124 and keeping it in the On position. In this embodiment, the switch lock 122 covers part of the light switch cover plate 104, including its mounting screws 106, 108, although the switch lock 122 is not limited to this example embodiment. A side view of the locked light switch 120 is depicted in FIG. 4.

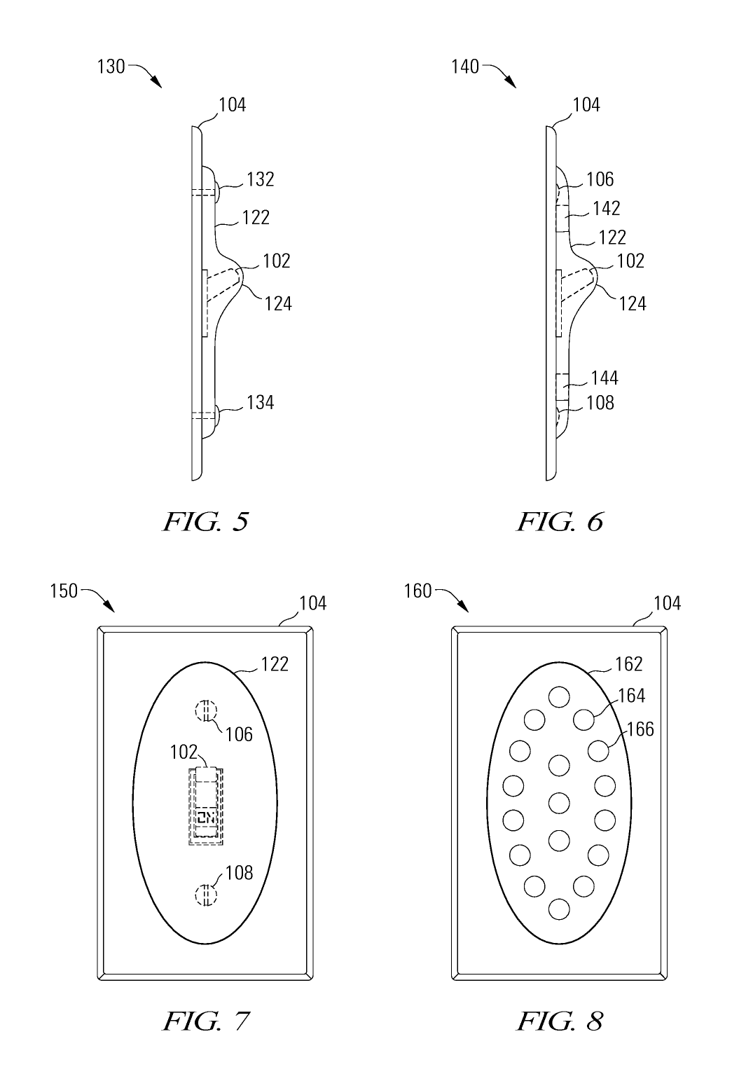

The switch lock 122 can be mounted in any suitable manner. For example, as depicted in FIG. 5, the switch lock 122 can be mounted by longer screws that pass through holes in the switch lock 122 and are tightened into the existing threaded holes in the light switch, replacing the shorter screws 106, 108 that hold the cover plate 104 in place. As depicted in FIG. 6, the switch lock 122 can be mounted by adhesive strips or tape 142, 144 to hold the switch lock 122 to the cover plate 104.

A switch lock 122 can be a simple cover that prevents a switch 102 from being turned off, as depicted in the diagram of a locked light switch 150 of FIG. 7.

Alternatively, a switch lock 162 can be provided with a user interface or other circuitry, I/O elements (e.g., 164, 166), indicators, solar panels, other energy harvesters, etc., as depicted in the diagram of a locked light switch 160 of FIG. 8. For example, buttons or IR and/or visible LEDs, photovoltaics, photosensors, photo transistors, photo diodes, etc., other types of sensors, combinations of these, etc. can be provided on a switch lock (e.g., 162). The present invention can also work with and include other types of buttons that can be powered by one or more or any of the methods discussed herein and can be one or more of wireless, wired, PLC.

Although essentially circular shapes are shown for the buttons, contacts, sensors, LEDs, etc., any shape or form in general may be used including but not limited to square, rectangular, diamond, oval, elliptical, triangular, pentagon, hexagon, octagon, arbitrary, essentially any shape or form, etc., combinations of these, etc. Embodiments of the present invention can be basically 2-D.

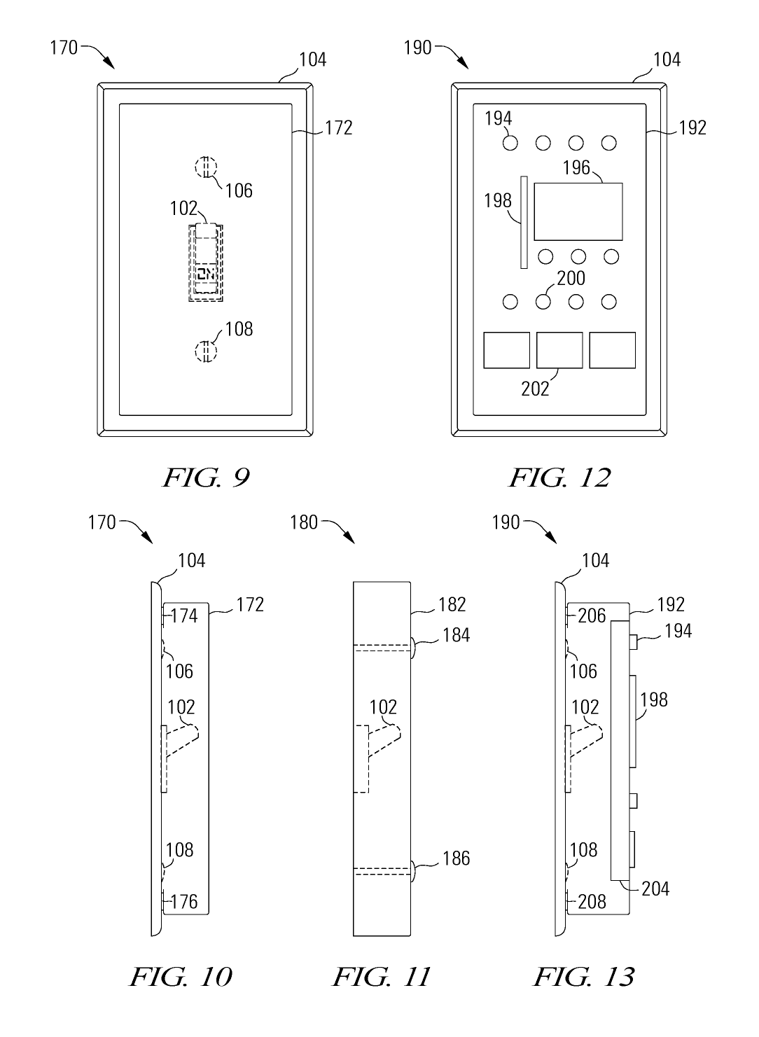

Turning to FIG. 9, a locked light switch 170 is depicted with a rectangular switch lock 172 over a light switch 102 and cover plate 104 in accordance with some embodiments of the invention. Again, the switch lock 172 can be mounted in any suitable manner. For example, the locked light switch 170 of FIG. 10 includes a switch lock 172 mounted by adhesive strips 174, 176 to the cover plate 104. The locked light switch 180 of FIG. 11 includes a switch lock 182 which entirely replaces a cover plate, mounted by screws 184, 186 through the switch lock 182 into threaded holes in the light switch 102.

Turning to FIG. 12, an example locked light switch 190 includes a rectangular switch lock 192 over a light switch and cover plate 104, where the switch lock 192 includes with user interface elements (e.g., 194, 196, 198, 200, 202), energy harvesters, etc., in accordance with some embodiments of the invention. Such user interface elements can be used, for example but not limited to, for controlling a smart solid state lighting system powered through the locked switch. The smart solid state lighting system thus remains powered in at least a standby mode, so that it can be activated and controlled by the user interface elements (e.g., 194, 196, 198, 200, 202) to turn on and off lighting, control color, dim the lighting, etc. The user interface elements (e.g., 194, 196, 198, 200, 202) can be supported by circuitry, processors, control circuits, and/or user interface circuits etc. 204 (see FIG. 13) housed in the switch lock 192, and can be connected to the smart solid state lighting system or other load by wireless and/or wired communications links.

The switch lock (e.g., 192) can comprise a cover over a light switch that is functional and cosmetically pleasing and/or acceptable. Again, such a cover could have one or more of the following: buttons, switches, knobs, sliders, sensors, detectors, etc. including but not limited to motion, sound, voice, voice recognition, noise, light, daylight harvesting, vibration, temperature, humidity, smoke, fire, carbon monoxide, carbon dioxide, ultrasonic, radar, microwave, RF, millimeter-wave, etc., SSLs of any type(s) and combination(s) including but not limited to infrared and visible LEDs, OLEDs, QD LEDs, etc., other types of LEDs, power sources including but not limited to battery or batteries, battery charger(s), power acceptors and absorbers including solar power, photovoltaic power, light power, vibrational power, acoustic power, wireless power transfer (including having, for example, one or more coils incorporated/integrated/etc. into the cover, mechanical, heat, thermal, wind, other energy sources, other alternative energy sources, etc. combinations of these. Other embodiments of the present invention can use light sources that are not smart/intelligent connected, enabled, for example, but not limited to, incandescent, florescent, solid state lighting, etc. which are not themselves able to communicate by wired or wireless or powerline communications but, could for example, by dimmed by a duty cycle or phase cut dimmer, dimming signal such disclosed in patent application Ser. No. 15/314,321 filed Nov. 28, 2016 for “Lighting Systems”, incorporated herein by reference for all purposes, which can provide a wired, wireless and/or powerline signal to perform dimming including phase cut/phase angle/pulse width modulation (PWM)/other duty cycle dimming, etc. For example, but not limited to, an Edison socket (e.g., E26 in North America and E27 in Europe, etc.) adaptor that can be inserted (and screwed in) in between the light source/lamp and the lamp socket. Other embodiments can use, for example, but not limited to, MR16, GU 10, PLC, florescent tombstones, HID sockets, etc. In the event that the light source is not dimmable, then the present invention can be used to turn on and off the light source(s) or the one(s) of the light sources that are not dimmable, etc. Embodiments of the present invention can use, for example, but not limited to the internet, the web, Ethernet, cellular carriers and providers (e.g., Verizon, ATT, T-Mobile, Sprint in the USA) including but not limited to modems, satellite, cable, be cloud-based, etc., combinations of these, etc. to allow both local and world-wide control from virtually anywhere on the Earth or even in Space.

Such buttons and switches could have and perform multiple functions for example but not limited to how many times the button was depressed/activated, the length of time that the button was depressed/activated, etc. Again, although essentially circular shapes are shown depicted for the buttons, contacts, sensors, LEDs, etc., any shape or form in general may be used including but not limited to square, rectangular, diamond, oval, elliptical, triangular, pentagon, hexagon, octagon, arbitrary, etc., combinations of these, etc. Embodiments of the present invention may have more or less user interface(s), energy harvesters, sensors, etc. than what is depicted in the Figures.

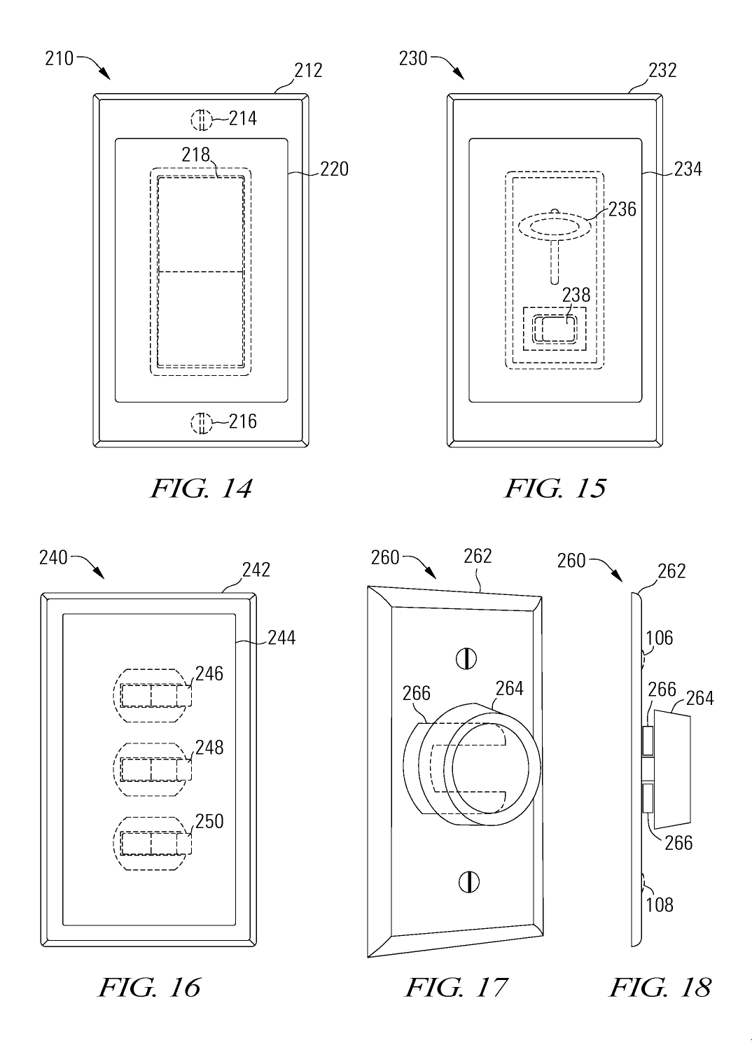

Again, the switch lock is not limited to use with any particular type of switch or number of switches. The example locked switch 210 of FIG. 14 includes a switch lock 220 that covers a decorative rocker style light switch 218, in this example exposing at least a part of the cover plate 212 and screws 214, 216, although the switch lock 220 can also cover or replace the cover plate 212. The example locked switch 230 of FIG. 15 includes a switch lock 234 that covers a dimming light switch slider 236 and rocker switch 238. The locked switch 210 of FIG. 14 includes a switch lock 244, mounted to a cover plate 242, that covers three light switches 246, 248, 250, keeping them all on. In some other embodiments, the switch lock 244 can be configured to configure one or some of the switches, exposing one or several switches to allow them to be turned off while keeping at least one of the light switches 246, 248, 250 turned on. In some embodiments, a switch lock can be used to keep power partially supplied, for example allowing a dimmer to still be operated without completely being turned off. For example, the locked switch 260 of FIGS. 17 and 18 includes a rotary dimmer 264 that is designed to be pressed to turn power completely off and to be rotated to dim or reduce the power through the switch. In this embodiment, when the rotary dimmer 264 is turned to its lowest level, it may still pass enough current to supply a control circuit in a solid state lighting system. In this embodiment, the switch lock 266 comprises a plate or clip that slides behind the rotary dimmer 264 between the cover plate 262 and rotary dimmer 264, preventing it from being pressed in to turn off the power, but allowing it to be turned to dim the power. Embodiments of the present invention can also cover, replace, augment, etc. one or more switch plates for example, but not limited to, more than one gang box such as two, three of four gang box each which may have one or more than one switch per gang box location for example, but not limited to, one or more toggle switches of any kind or type, one or more dimmers of any type including but not limited to rotary, rotary knob, touch panel, slider, linear slider etc.

Based upon the disclosure provided herein, one of ordinary skill in the art will recognize a variety of shapes and forms that can be used in a switch lock to prevent the switch from being turned off, as well as a variety of user interface elements, circuits, etc. that can be included in the switch lock.

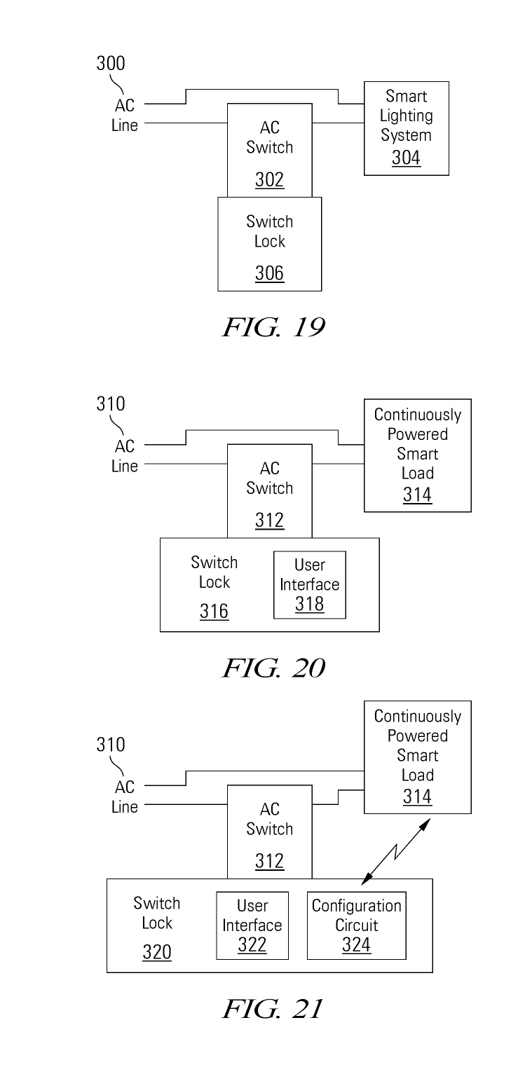

Turning to FIG. 19, a block diagram of a smart lighting system is depicted. A light switch 302 is provided to switch (pass or block) power from an AC input 300 to a smart lighting system 304. The light switch 302 can be of any type. In some other embodiments, the input power is DC power. The smart lighting system 304 can include any lighting elements, such as, but not limited to, LED, OLED, quantum dot, etc. and/or other types of light sources, and can also include power supplies, control circuits, sensors, etc. A switch lock 306 is connected to the light switch 302, preventing it from being turned off, so that the smart lighting system 304 (or at least control circuits in the smart lighting system 304) remain powered. A smart/intelligent lighting system 304 can thus be installed in a house with a legacy light switch 302, without replacing the light switch 302, rewiring to provide another source of power to the smart lighting system 304, and without risking the smart lighting system 304 being turned off and losing part of its functionality such as, but not limited to, sensor operation, remote control, scheduling, etc.

Turning to FIG. 20, a block diagram depicts a continuously powered smart load 314 with a light switch 312 and switch lock 316 with user interface 318 in accordance with some embodiments of the invention. The switch lock 316 prevents the light switch 312 from being turned off, allowing the continuously powered smart load 314 to draw power from the AC line 310 at least in a standby mode.

As depicted in FIG. 21, the switch lock 320 can include a configuration circuit 324 to communicate with/control the continuously powered smart load 314. For example, the switch lock 320 can be used with any smart, intelligent, connected, etc. lighting system, and can include a configuration circuit/memory that configures the switch lock 320 based on the type or model of smart lighting system, so that the user interface 322 is able to control the functions of the smart lighting. Again, communication between the circuits in the switch lock 320 and the continuously powered smart load 314 can be wireless (as depicted) using one or more wireless communications protocols, or can be wired.

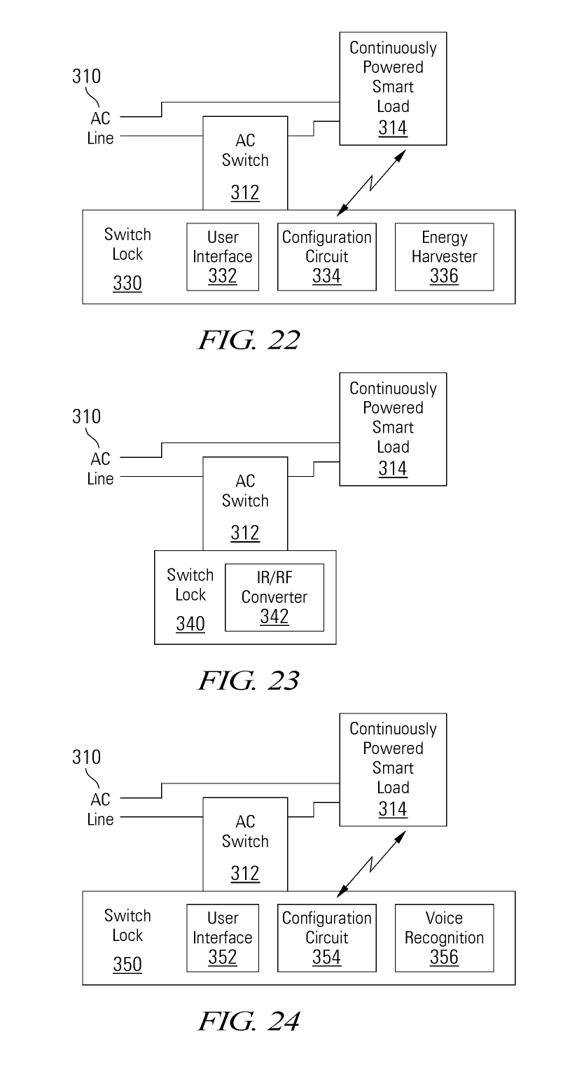

As depicted in FIG. 22, the switch lock 330 can include a configuration circuit 334 to communicate with/control the continuously powered smart load 314. For example, the switch lock 330 can be used with any smart lighting system, and can include a configuration circuit/memory that configures the switch lock 330 based on the type or model of smart lighting system, so that the user interface 332 is able to control the functions of the smart lighting. The switch lock 330 can further include one or more energy harvesters 336 to power circuits in the switch lock 330, to recharge batteries, if provided, in the switch lock 330, or for other purposes.

As depicted in FIG. 23, the switch lock 340 can include an IR/RF or other types of wireless or wired converters to translate/relay wireless commands, for example but not limited to between a remote control and a lighting system, fixed and/or variable speed fan, motor, entertainment system, heater, air conditioner, humidifier, thermostat, HVAC system, entertainment system, infotainment system, computer, security system(s), surveillance, fire alarm(s), smoke alarm(s), health monitoring systems, environmental monitoring, sensor including sensors of any type including but not limited to light intensity, light color temperature, optical and/or visible spectrum sensors, ambient light sensors, motion sensors of any type or form, temperature sensors, pressure sensors, photoelectric sensors, door sensors, window sensors, floor sensors, vibration sensors, gesture sensors, emotion sensors, human sensors, cellular phone sensors, near field communications (NFC) sensors, other Internet of Things (IOT) sensors, etc., combination of these, etc., including those mentioned and discussed herein, etc.

As depicted in FIG. 24, the switch lock 350 can include a user interface 352, configuration circuit 354, and voice recognition system 356, enabling voice commands to be used to communicate with/control the continuously powered smart load 314. Other embodiments based on for example, but not limited to, FIG. 24, can use gesture, motion, emotion, etc., other types of detection and sensing discussed herein, combinations of these, etc.

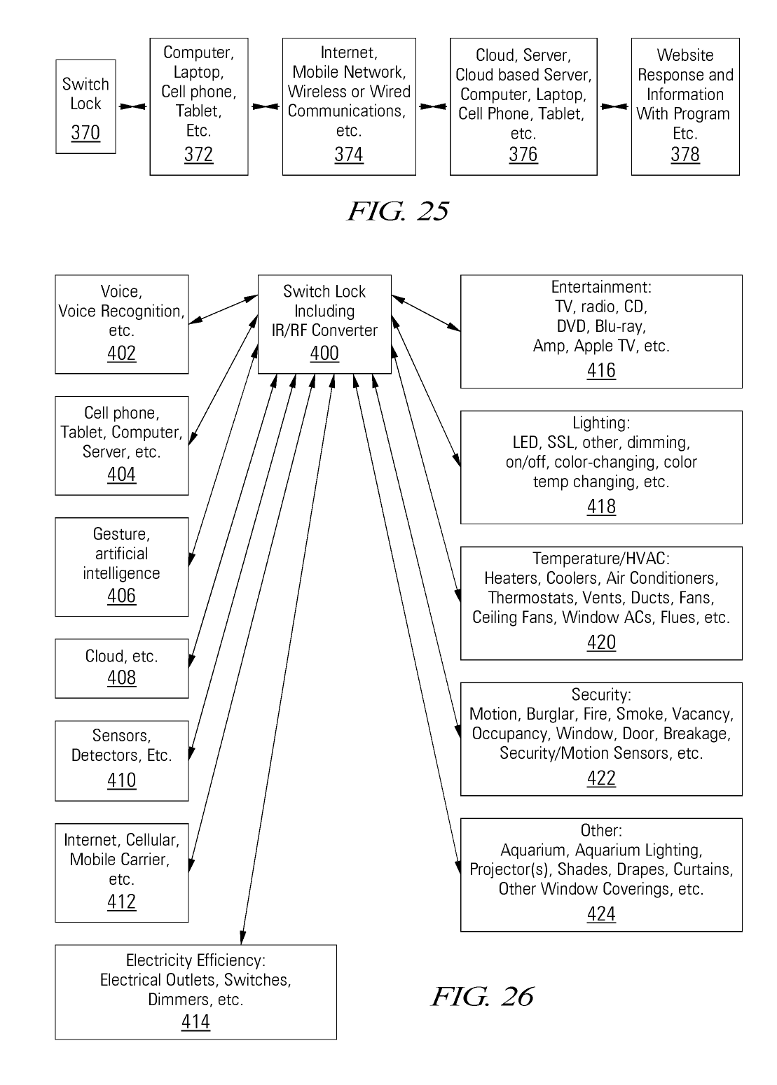

Turning to FIG. 25, a switch lock 370 is depicted in a block diagram with various non-limiting interfaces that can communicate with circuits in a switch lock in accordance with some embodiments of the invention, including, but not limited to, a computer, laptop, cell phone, tablet, etc. 372, the Internet, a mobile network, wireless or wired communications, etc. 374, the cloud, server, cloud based server, computer, laptop, cell phone, tablet, etc. 376, website response and information with program, etc. 378.

Turning to FIG. 26, a switch lock 400 with example IR/RF converter or other interface(s) is depicted with various non-limiting example systems that can be used with the switch lock in accordance with some embodiments of the invention. The switch lock 400 can be used with voice recognition systems 402, cell phones, tablets, computers, servers etc. 404, gesture recognition systems, artificial intelligence systems 406, cloud based systems 408, sensors, detectors etc. 410, Internet, cellular, mobile carrier networks 412, etc. The switch lock 400 can be used with systems for improving energy efficiency, such as, but not limited to, electrical outlet controllers, switches, dimmers, etc. 414. The switch lock 400 can be used with entertainment systems, such as, but not limited to, TV, radio, CD, DVD, Blu-ray, amplifiers, streaming systems such as, but not limited to, Apple TV, etc. 416. The switch lock 400 can be used with lighting systems, such as, but not limited to, LED, SSL, other, dimming, on/off, color-changing, color temp changing, etc. 418. The switch lock 400 can be used with temperature control/HVAC systems, such as, but not limited to, heaters, coolers, air conditioners, thermostats, vents, ducts, fans, ceiling fans, window ACs, flues, etc. 420. The switch lock 400 can be used with security systems, such as, but not limited to, motion, burglar, fire, smoke, vacancy, occupancy, window, door, breakage, security/motion sensors, etc. 422. The switch lock 400 can be used with other systems, such as, but not limited to, aquarium, aquarium lighting, projector(s), shades, drapes, curtains, other window coverings, etc. 424.

Various embodiments of the invention can control space heater(s) from IR, monitor heater power consumption from AC outlet/receptacle and also be able to completely turn off space heater from AC outlet/receptacle including for safety reasons.

Various embodiments of the invention can control TV and Apple TV and set additional sound system to desired volume, intensity, etc. Adjust (Control and Monitor) room temperature and lighting including dimming, and optionally color temperature, color, etc. for that room in particular while conserving energy consumption elsewhere in the house/residence/apartment/condo/etc. including HVAC and electrical, lighting, etc.

Various embodiments of the invention can detect arrivals at a location and turn room temperature in desired locations to preferred values and adjust ambient conditions including lighting, sound, music, TV, cable, satellite, etc.

Various embodiments of the invention can be used to monitor and, as needed, control electrical, lighting, temperature, health status and conditions for assisted living and remote assisted help in living situations. Can monitor (and control) temperature, lighting including but not limited to lighting for treatment of illness(es) and well-being, including but not limited to dementia, Alzheimer, Parkinson, Circadian Rhythm, Cancer, seasonal affective disorder (SAD), depression, etc. as well as humidity, general health, etc. Implementations and embodiments of the present invention can use microphone and speakers (and earphones, headphones, hearing aids, etc.) to communicate between the assisted liver(s) and support people including family, friends, neighbors, etc. Implementations and embodiments of the present invention can also monitor vital signs including pulse, heart beat/rate, blood pressure, oxygen levels, vertical or horizontal position, inclining, etc., whether a fall has occurred, etc. Can remotely track where the persons are in a dwelling and remotely monitor and adjust temperature, lighting, etc. as needed. Implementations and embodiments of the present invention can set lights to be of certain wavelengths/colors at certain times of the day, night, etc. The present invention can be used in any location or environment, dwelling, facility, etc., rural or urban, etc. The present invention can be used in a retirement home, a senior citizen home or community, hospital, hospice, maternity wing, long term recovery facility, assisted living dwellings or communities, convalescence homes and facilities, etc. Can be used in virtually any location where infrared and RF signals are used to control and monitor, etc.

The present invention can be used in a classroom environment to control the lighting and temperature as well as audio-visual (AV) equipment including but not limited to controlling televisions, monitors, projectors, windows, window coverings, lighting including on/off and dimming, DVDs, internet connections, other media sources, etc. The lighting can be adjusted, for example, but not limited to, in intensity/dimming and color temperature or color/wavelength to, for example, aid in focusing and increase productivity.

The present invention can be used in a conference room or similar environment to control the lighting and temperature as well as audio-visual (AV) equipment including but not limited to controlling televisions, monitors, projectors, windows, window coverings, lighting including on/off and dimming, DVDs, internet connections, other media sources, etc.

The present invention can be used in a business to control the temperature, the lighting, the humidity, the security, etc. to enhance personal needs, comfort, functioning, efficiency including energy efficiency and human/personnel efficiency.

The present invention can be used in libraries, call-centers, telemarketing centers, lounges, lunchrooms, etc. to increase energy efficiency and reduce energy usage while also allowing for personal preferences.

The present invention can be used indoors as well as outdoors and can coordinate between indoor and outdoor.

The present invention can use any RF frequencies including but not limited to industrial, scientific, and medical (ISM) frequencies typically in the MHz to low GHz range. However embodiments of the present invention can use frequencies higher or lower than this range.

The present invention can have global positioning (GPS) incorporated into embodiments of the present invention and connected to embodiments of the present invention.

The present invention can work with other RF devices and technologies including WiFi, Bluetooth, Cellular modules/radios, etc. and can also detect and monitor other WiFi, Bluetooth signals emitted from ‘traffic’ nearby. Can detect arrival, proximity, etc. of users (and non-users) of the system and act accordingly including making inter- and intra-decisions as to what to control, monitor, log, report, alert, alarm, turn off/on, dim, etc.

The present invention can be used for retrofitting and can for example, but not limited to, use chip on board (COB), through hole, surface mount (SMT), etc., combinations of these SSL including LEDs that include but are not limited to the infrared and visible spectrum as well as both of these.

The present invention can produce RF control signals to control, for example, but not limited to fans including ceiling fans, electrical outlets, satellite TV boxes, cable boxes, other entertainment components, etc. using one or more RF frequencies typically in the range of low MHz to low GHz, including, for example, but not limited to 13.6 MHz, 27 MHz, FM frequency range, ISM frequencies in the range of more than 100 MHz to less than 6 GHz, etc. The present invention can determine the frequency and other features of RF remote controls and reproduce the frequency and associated patterns using, for example but not limited to, spectrum analysis techniques, methods, technologies and phase lock loop and other RF techniques, methods, technologies, architectures, etc.

The present invention can take a picture/photo/rendering/etc. of a space including but not limited to a space with cubicles and take such a picture, etc. and, for example, but not limited to, turn it into a CAD ‘drawing’ that can then be modified/enhanced/augmented/etc. to include/display/represent/show how the cubie-light would look on the picture and even show how the lighting would look including for example, but not limited to, having a virtual control panel that would allow the user to experience the lighting including features/functions such as color temperature, color tuning, color/wavelength (i.e., red, green, blue, amber, yellow, etc.) using for example but not limited to ray tracing or other methods and techniques to accurately portray/display/render/etc. the cubie-top lighting, light patterns, effects, etc., combinations of these, etc., dimming, zoning, commissioning, etc.

The present invention can control flashing on/off of lights connected to the switch lock to indicate which lamp is being addressed/configured/self-configured as part of the self-configuring process, reconfiguring, rezoning, recognition, etc., combinations of these, etc.

The present invention can be incorporated into a lamp, a bulb, an Edison socket bulb, be a bulb, a security and/or motion light or fixture, a fixture, a lighting fixture, a lighting luminaire, a heater, a fan, a fixture of any type or form, a free standing lamp, a light strip, a LED strip, a LED strip with infrared LEDs mixed in with one or more white color temperature LEDs, one or more color LEDs, combinations of one or more color LEDs including but not limited to one or more of red, green, blue LEDs, one or more of red, green, blue, amber, yellow, orange, etc. LEDs, combinations of these, etc., a table lamp, a floor lamp, a desk lamp, an overhead lamp, a fluorescent lamp replacement of any type or form including SSL or LED or OLED or QLED, etc. fluorescent lamps replacement for compact fluorescent lamps (CFLs), linear fluorescent lamps, PL and PLC fluorescent lamps, as a stand-alone unit, as a light fixture on a wall or ceiling including but not limited to one or more of a sconce, pendant, can lamp, a downlight lamp, a spot light, a recessed light, a can light, a flush mount, a task lamp, a task light, a task fixture, a track light, a cove light, a disk light, a pendant, a replacement ceiling fixture, a light bar, a wall fixture, a wall washing light/fixture, a floor fixture, a table lamp, a flood light, a puck light, a task fixture, a desk lamp, a security light, a replacement light including but not limited to LED, OLED, SSL, etc., a porch light, a solar light, a ribbon light, a string light, an accent light, a lantern, a lantern light, a porch light, a patio light, a spot light or lights, a vanity fixture, a shelf, a spot light, a swivel light, a retrofit light, lamp, light fixture, lamp fixture, luminaire, etc. a fluorescent lamp replacement of any type or form including SSL or LED or OLED or QLED, etc. fluorescent lamps replacement for compact fluorescent lamps (CFLs), linear fluorescent lamps, PL and PLC fluorescent lamps, as a stand-alone unit, as a light fixture on a wall or ceiling including but not limited to a sconce, under cabinet, over-cabinet, etc. cubicle lighting personal lighting, essentially any type of light and/or light fixture, lamp, lamp fixture, fixture, etc., combinations of these, etc., such as, but not limited to, lighting systems disclosed in PCT Patent Application PCT/US16/69054 filed Dec. 28, 2016 for “Personalized Lighting Systems”, which is incorporated herein by reference for all it contains.

The present invention can be powered by AC, DC, energy harvesting, solar power, light power, RF power, wall wart, auxiliary power sources, etc., combinations of these, etc.

The present invention can communicate and can be controlled, monitored, logged, analyzed, analytics, etc. using smart, intelligent wearables and other types of communications including but not limited to watches, bracelets, etc.

Embodiments and implementations of the present invention can be very flat and nearly 2-Dimensional.

Embodiments and implementations of the present invention can use powerline communications (PLC) to control and monitor.

Embodiments and implementations of the present invention can setup the IR transmitters to only fire/turn-on/signal in certain locations, rooms, etc.

Embodiments and implementations of the present invention can include/incorporate/integrate/be sensor rich. IOT enabled, for example but not limited to temperature, humidity, etc.

Embodiments and implementations of the present invention can use/interact with (etc.) wearable devices such as headbands, glasses, wristbands, armbands, etc. Embodiments and implementations of the present invention can detect falling asleep by monitoring eye and eyelid movement, state of awake or sleep, by REM sleepiness, etc.

Embodiments of the present invention can work with or incorporated into a string, (e.g., in the form of a string of IR LED transmitters and/or IR receivers), can be draped over an existing fixture, can be made as a wall mount including an ‘invisible’ wall mount that can be attached to, blend in with, etc. a wall, window, door, ceiling, floor, etc.

Embodiments and implementations of the present invention can be solar powered, energy harvesting powered, remotely powered, wirelessly powered, etc., combinations of these, etc., battery powered, battery charged, have a battery charger that can receive energy and power from energy harvesting or wireless power or remote power and sources of remote power, etc., combinations of these, etc. can be battery powered with the battery being charged by alternative energy and/or energy harvesting, wireless power, remote sources of power, etc. Embodiment of the present invention can be made to be flexible including on a flexible substrate, printed circuit board, etc., or no boards, substrates, etc.

Embodiments and implementations of the present invention can use double sided tape to attach, sticky tape, 3M Contact, other 3M products, other company products, combinations of these, etc. Embodiments of the present invention can also use but is not limited to permanent, semi-permanent or temporary ways, methods, techniques, etc. to attach, adhere, support, connect, etc. to the existing infrastructure including but not limited to the wall switch, the power switch or other switches, etc. Embodiments and implementations of the present invention can be stuck on the ceiling, walls, other places, etc.

Embodiments and implementations of the present invention can be part of a light string, rope, etc.

Embodiments and implementations of the present invention can be used indoors and outdoors.

The present invention can be used as part of a thermostat including but not limited to using the furnace or air conditioner, including but not limited to central air and heating, HVAC in general, etc. to provide power for the present invention. Embodiments and implementations of the present invention can be part of furniture, desks, mirrors, cabinets, beds, bed frames, closets, closet doors, any type of door, window, etc. Embodiments and implementations of the present invention can have multiple repeaters, etc. Embodiments and implementations of the present invention can be part of a sprinkler system, security system, fire system, etc.

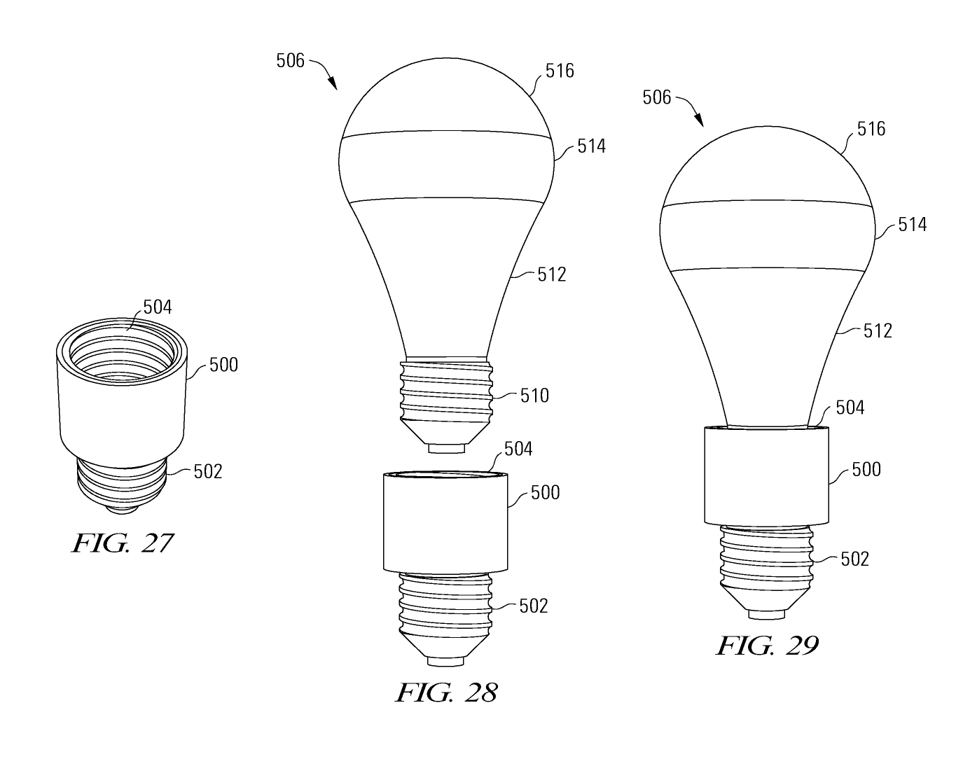

Turning now to FIGS. 27-29, some embodiments of the present invention include an in-socket solid state lighting-compatible controller/dimmer that can be used with a switch lock of any type, including, but not limited to, a passive cover type switch lock to maintain power to the in-socket controller/dimmer, and to circuits in a switch lock to communicate with/control the in-socket controller/dimmer Although any socket and any light source mounting technology can be used, the example embodiments of FIGS. 27-29 can include a male and female Edison E26 or medium screw base. The socket 500 includes a male Edison screw base 502 to connect to a light fixture, and a female Edison screw socket 504 to receive a solid state light 506, or any other type of light, including, but not limited to, an incandescent bulb, etc. The socket 500 includes power supply/driver circuits, wireless control circuits, on/off/dimming circuits, monitoring/control circuits, etc. as desired. In some cases, power supply/driver circuits, wireless control circuits, on/off/dimming circuits, monitoring/control circuits are also or alternatively located in the solid state light 506. The solid state light 506 includes a male Edison screw base 510, a housing 512 that can emulate the familiar shape of an incandescent bulb if desired that can house circuits, heat sinks, sensors, etc. The solid state light 506 includes a circuit board housing 514 in which one or more circuit boards can be mounted supporting one or more solid state lights of one or more colors, covered by a lens 516 that can include diffusers, filters, lenses, phosphor coatings, etc. as desired. In addition to solid state lighting, other types of lighting can be used including but not limited to incandescent and florescent lighting. Any type of lamp, lighting fixture, light bulb, light tube that uses a fixed switch can be used with embodiments of the present invention including ones that are dimmable and non-dimmable with the non-dimmable ones being able to be remotely switched on and off, etc.

The present invention can use smooth dimming up and down of lights in response to sensing and detection of any type including motion, speech, gesturing, and/or darkness, etc., combinations of these, etc. Dimming up and down can be instantaneous, timed, ramped, stepped, continuous, etc.

The present invention can also synchronize with time clock, world clock, weather, sunrise, sunset, atomic clock, clock and websites of any type and form, etc.

The present invention can work with any type of load including dimmable and non-dimmable and any type of voltage or frequency including universal AC (i.e., 80 VAC to 277 VAC), 347 VAC, 480 VAC, 47 Hz or lower, 50/60 Hz, 63 Hz or higher, 400 Hz, any other frequency, low AC voltage (e.g., 12 VAC, 24 VAC, or lower or higher), DC from low voltage to high voltage such as 12 VDC or lower, 100 VDC, 430 VDC, 1000 VDC, etc. The present inorsvention can also work with magnetic loads, including low voltage and high voltage magnetics, transformers, fans, motors, lighting, combinations of these, etc.

In some embodiments of the present invention, the load or lighting system can two-way communicate with circuits in a switch plate including but not limited to dimming up or down in a prescribed manner including dimming smoothly over a certain amount of time in certain scenarios and including but not limited to turning full on in safety or emergency related situations. In a like-wise fashion, other lights including both interior/inside and exterior/outside lights could respond in similar, appropriate, etc. ways and operations, etc.

Lighting systems with switch locks disclosed herein provide personalized control over one's lighting environment, such as, but not limited to, digital dimming level, white color temperature tunability, full-spectrum color tunability, light direction, trimming including maximum and minimum trimming, scheduling, scenes, intruder detection, alarming, and sensor thresholds (daylight & occupancy). This can serve to improve adoption of energy efficiency as well as personalization, improved comfort, increased productivity, increased health, proper exposure to light therapeutic effects, therapy, circadian rhythm alignment, maintenance, etc., treatment of seasonal affective disorder (SAD), treatment of depression, illness, disease, etc., healing, etc., combinations of these, etc. including solid-state lighting or other lighting and allow adapting to occupant types and preferences for, as examples, improved productivity, human reaction, or appeal of the space. Circuits in the switch lock, e.g., control circuits, communications circuits, user interface circuits, etc. can thus be used to program and control a lighting system powered through the switch, using any suitable communications methods (e.g., wireless, wired of any type), for therapeutic as well as aesthetic and utilitarian purposes. Light control can be performed based on sensor input such as, but not limited to, light level, light color, spectrum content, data from networks such as the Internet or cellular or other networks such as, but not limited to, sunlight data, sunrise/sunset data, expected wavelength or spectrum content in sunlight based for example on location, time of day, season, time of year, etc. Light control can also be based on healthcare provider prescription or instruction, activities being performed in the vicinity, detected motion or sound, etc. The switch lock can be quickly installed by users without specialized electrical knowledge, without requiring complex/expensive ceiling wiring, and can be used in both new and old construction. Implementations of the present invention can be self-commissioning, self configuring, etc., combinations of these, etc.

Implementations of the present invention can also control other devices, circuits, wall or other power, can work with AC or DC power switches, power outlets, etc.

In some embodiments, the personalized lighting system can react to other detected conditions or emergency situations, such as providing lighting if a fire is detected, flashing if unauthorized entry is detected, etc., including but not limited to functions described in PCT patent application PCT/US16/56924 filed Oct. 13, 2016 for “Solid State Lighting and Sensor Systems”, which is incorporated herein by reference for all purposes.

Some embodiments of the present invention may use multiple dimming or control (i.e., accept dimming information, input(s), control from two or more sources).

Remote interfaces include, but are not limited to, 0 to 10 V, 0 to 2 V, 0 to 1 V, 0 to 3 V, etc., RS 232, RS485, DMX, DALI, WiFi, Bluetooth, ZigBee, IEEE 802, Zwave, Thread, 6LoWPAN, IPv4, IPv6, two wire, three wire, SPI, I2C, PLC, and others discussed in this document, etc., combinations of these, etc. In various embodiments, the control signals can be received and used by, for example, but not limited to, SSL including but not limited to LED, OLED and/or QD lighting.

The solid state lighting systems can include single and multi-color lights including RGB, White plus red-green-blue (RGB) LEDs or OLEDs or other lighting sources, RGB plus one or more colors, red yellow blue (RYB), other variants, etc. Color-changing/tuning can include more than one color including RGB, WRGB, RGBW, WRGBA where A stands for amber, etc. 5 color, 6 color, N color, etc.

Color-changing/tuning can include, but is not limited to, white color-tuning including the color temperature tuning/adjustments/settings/etc., color correction temperature (CCT), color rendering index (CRI), etc. including but not limited to with one or more of a red, green, blue, amber, cool white (i.e., relatively high kelvin color temperature), warm white (i.e., relatively low Kelvin color temperature), etc., combinations of these, etc., combinations that produce full spectrum lighting, etc.

Color rendering, color monitoring, color feedback and control can be implemented using wired or wireless circuits, systems, interfaces, etc. that can be interactive using for example, but not limited to, smart phones, tablets, computers, laptops, servers, remote controls, etc. The present invention can use or, for example, make, create, produces, etc. any color of white including but not limited to soft, warm, bright, daylight, cool, etc. Color temperature monitoring, feedback, and adjustment can be performed in such embodiments of the present invention. Some embodiments of the present invention can change to different colors when using light sources capable of supporting such (i.e., LEDs, OLEDs and/or QDs including but not limited to red, green, blue, amber, white LEDs and/or any other possible combination of LEDs and colors).

Embodiments of the present invention have the ability to store color choices, selections, etc. and retrieve, restore, display, update, etc. these color choices and selections when using non-fluorescent light sources that can support color changing and can also coordinate, copy, duplicate color setting including but not limited to color settings that are stored, coded, interpreted, etc. in digital format.

The power supply/supplies and/or driver(s) controlled by circuits in a switch lock can be any suitable circuit based on the requirements of the solid state lighting and the voltage and/or current output, such as, but not limited to, a dimmable constant current driver. The solid state lighting can be any type of solid state lighting including but not limited to light emitting diodes (LEDs), organic light emitting diodes (OLEDs), quantum dot-based (QD)-based LEDs, etc. The solid state lighting can comprise a digital lighting platform as well as a sensor, detector, communications, etc. power hub, source and support for digital communications of all types and forms including but not limited to big data, environmental, information, entertainment, infotainment, etc.

Power can be converted by power supply/power supplies to power loads which can be, but are not limited to, internal circuits in the solid state lighting system, sensors, internet of things (IOT), sensors, detectors, devices, etc. including but not limited to those discussed herein such as motion of any type including but not limited to ultrasonics, PIR, passive infrared, infrared (IR) that use reflectance to detect motion and/or the presence of humans or other living or inanimate objects, sound, light, gesture, noise, voice, command recognition, voice recognition based on, for example but not limited to, cloud, cellular, smart phones, computers, tablets, personal digital assistants (PDAs), etc., combinations of these, text messages, e-mails, etc., combinations of these, etc., temperature, etc., sensors, detectors, controllers, as well as communications devices including but not limited to wireless, wired, powerline, etc., combinations of these, etc.

In some embodiments, the power supply or supplies in some embodiments of a switch lock can be used to generate power for internal circuits, sensors, etc. as well as external circuits, sensors, IOT, controls, communications, detectors, sirens, cameras, arrays, pattern, voice, sound, facial, etc. sensors, detectors, etc., combinations of these including but not limited to those discussed herein without impacting the constant current to the lighting output(s). In some embodiments of the present invention, the light output may be directly controlled or regulated with one or more isolated or non-isolated outputs may be used to provide internal and/or external power to sensors, IOT, controls, communications, etc., combinations of these, etc.

Some embodiments of the invention include Identification Switches with, for example but not limited to, RFID and/or NFC. Various embodiments can have mechanical to electrical switching and/or gesture detection, etc., for example, but not limited to ZigBee to RFID, BTLE to RFID, etc. Control circuits can interface powered by any source, including but not limited to, power from the AC line, power from one or more batteries, one or more solar cells of any type or form including to, but not limited to, inorganic, semiconductor, organic, quantum dot, etc., battery charger, vibration energy converter, RF converter, energy harvester of any type and source, etc., power of Ethernet, DC power sources, AC to DC conversion, etc., combinations of these, etc. The switch or actuator can be of any type including toggle, momentary, mechanical to electrical switch and/or gesturing, touch, capacitive sensing, etc. that could, for example, but not limited to also use ZigBee to RFID, BTLE to RFID, etc. WiFi to RFID, vice-versa, etc., two-way communications, etc. Embodiments of the present invention can also be powered by low voltage output power sources (e.g., 2208, 2218) including with power over Ethernet (POE). Power switching and/or dimming can be of any known type including but not limited to electro-mechanical, reed, latching, other electrical and/or mechanical, solid state, etc., relay(s), triac, silicon controlled rectifier (SCR), transistor, etc., more than one of one, more than one of each, combinations of one, combinations of each, other combinations, etc.

Some embodiments of the invention include circuits to link to watches and in particular smart watches, wearable watches, health monitoring watches, FitBit, Apple, Nike, Android based smart watches and wearables, Microsoft-based devices, smart watches, wearables, etc., combinations of these, etc.

Some embodiments of the invention include circuits to link to watches and/or other types of wearables to interact with, control, dim, monitor, light and other systems.

Some embodiments of the invention include motion detectors for indoor and/or outdoor outside that can have motion sensor, ultrasonics, noise, etc. separate from the light source and connected via Bluetooth Smart, BLE, USB, use WEB and other info including but not limited to weather, wind, wind speed, could coordinate with other sensors, lights, etc., including but not limited to feedback information, other forms and sources of information, etc.

Some embodiments of the invention includes lamps that can be all or partially screen printed, 3D printed, etc. including custom designs, customized designs, etc. using, for example, UL or CE approved, recognized, listed, etc. materials.

Some embodiments of the invention use proximity sensors and/or beacons, identifiers, etc. to identify who is near including by cellular/smart phone, smart watch, other Bluetooth devices, RFID, others, etc. and take appropriate actions including settings selection based on profile information stored, learned, taught, trained, memorized, etc., combinations of these, etc.

Some embodiments of the invention advertise and obtain Bluetooth and other ID, etc.

Some embodiments of the invention use display panels including but not limited to OLED panels, tablets, etc. as lighting panels.

Some embodiments of the invention include motion sensing for either outdoor or indoor that can wirelessly, wired and/or powerline communications set, program, control, monitor, log, respond, alert, alarm, etc. including being able to be part of a cluster, group, community of lights, etc., that provides, for example, but not limited to, protection and security, etc., can, for example, but not limited to, detect a defective light, light (burned) out, can provide dimming, can use one or more colors of white, RGB, etc., can dim up and dim down, etc., Implementations of the present invention can control, set, program, sequence, synchronize, etc. all parameters including but not limited to distance, length of time on, sensitivity, ambient light level, response, synchronizing with outdoor and indoor motion sensors, response including but not limited to white color temperature and/or color choice(s), flashing or solid on, flashing, sequences of flashing, sequences of flashing and solid on, etc. of one or more colors including but not limited to one or more white colors, one or more white colors with one or more other colors, one or more colors,

Some embodiments of the invention include sensors in the light(s), sensors attached to and/or near the light(s), sensors remote from the lights including battery powered, AC powered, solar powered, energy harvested, battery charged, etc., combinations of these, etc., including, for example, but not limited to, solar power battery charging.

Some embodiments of the invention are adapted for use in stairwells, etc. especially ones that have doors to entry, use a device that makes a sound when the door is opened so that the light source ‘hears’ the sound and turns on. Implementations of the present invention can use any device, approach, method, etc. that can convey that the door is opened or someone has passed through the door including, for example, but not limited to, photoelectric beam and photoelectric eye, magnetic proximity switch, other types of detection of open door, etc., can use two tone or more tone frequency, etc.

Some embodiments of the invention can use active or passive or both high pass, low pass, bandpass, notch, other filters, combinations, etc. including with the voice, sound, noise detection.

Some embodiments of the invention can flash at the end of an allotted time to indicate that the next group is ready to use, for example, a conference room.

Some embodiments of the invention can listen for and respond to emergency sounds such as smoke, fire, carbon monoxide (CO), carbon dioxide (for, for example but not limited to, both health and occupancy information), etc. detectors, sensors, etc. by flashing, turning on, forwarding the information, alert, alarm, etc.

Some embodiments of the invention can be powered over Ethernet (POE), dimmed, controlled, monitored, logged, two way communicated with, data mined, analytics, etc. Can be powered, controlled, monitored, managed, etc. via wired or wireless or powerline control (PLC) including but not limited to serial communications, parallel communications, RS232, RS485, RS422, RS423, SPI, I2C, UART, Ethernet, ZigBee, Zwave, Bluetooth, BTLE, WiFi, Thread, LoRa, cellular, mobile, ISM, Wink, powerline, etc., combinations of these, etc.

A wired and/or wireless controller/dimmer/monitor can be used for use in a solid state lighting system in accordance with some embodiments of the invention. Solid state lights of any color or of variable color, or of any color temperature or combinations of such, such as, but not limited to, red, green, blue, amber, white, etc. and of any type can be provided. In some embodiments, an on/off switch is provided. In some embodiments, a button/switch/etc. is provided for turning on/off one or more parts of the present invention. In some embodiments, a control interface is provided, which can be wired (i.e., analog and/or digital, serial, parallel, UART, SPI, I2C, RS232, RS485, RS422, other RS/EIA, etc. standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.) or wireless (Bluetooth, Bluetooth low energy, WiFi, IEEE 801, IEEE 802, ZigBee, Zwave, other 2.4 GHz and related/associated standards, protocols, interfaces, ISM, sub-GHz, other frequencies including but not limited to, radio frequencies (RF), microwave frequencies, millimeter-wave frequencies, sub millimeter-wave frequencies, terahertz (THz), mobile cellular network connections, combinations of these, etc.) In some embodiments, a powerline interface is included to control lights or other devices. In some embodiments, an encoder or potentiometer is included for manual control. In some embodiments, a button/switch is included for enabling/disabling/controlling dimming of parts or all of the present invention. In other embodiments, buttons including but not limited to two or more buttons can be used to, for example but not limited to dim up or down. In other embodiments, color temperature, color spectrum, intensity, trimming, etc. may be controlled in a similar method, fashion, manner, etc. Again, such a wired and/or wireless controller/dimmer/monitor is a non-limiting example of a control interface for a solid state lighting system.

A solid state lighting system can be color controllable multiple light sources in accordance with some embodiments of the invention. For example, a solid state lighting system may include a solid state light with multiple flat lighting panels (e.g., OLED panels or edge-lit panels) and multiple solid state point light sources, such as LEDs. The shape, layout, form factor, and types and numbers of light sources are merely examples and should not be viewed as limiting in any manner. Embodiments of the present invention can also have lighting on the outside of, for example, the light bar, panel, etc. including direct lit, edge lit, back lit, etc. Some example embodiments are shown below which can also include one or multiple LEDs, OLEDs, QDs that can consist of one or more of white, red, green, blue, amber, yellow, orange, etc. In addition, such lighting can be used to convey information about the status of a situation including flashing lights which may convey emergency situations, etc. In some embodiments, the SSL can provide evening/night light using for example amber-orange-yellow SSLs including but not limited to LEDs and/or OLEDs that can be dimmed, flashed, color-changing, sound alarms, sequence, provide time of day and circadian rhythm and/or other health therapy or ailment alignment, information, etc. Some embodiments of the present invention can have light, motion, proximity, noise, sound RFID, NFC, etc. sensors that are either internal or external and connected by one or more of wired, wireless, powerline communications (PLC), etc.

Some embodiments of the present invention can include LEDs. OLEDs, QDs, other SSLs, other types of lights, etc. combinations of these, etc. and can include combinations of flashing, sequencing, dimming, changing colors, individually and/or collectively, etc., sirens, alarms, alerts, web connectivity, wired, wireless and/or PLC, etc.

Example embodiments of solid state lighting systems with isolated control inputs can be used in accordance with some embodiments of the invention. The lighting, lamps including but not limited to SSL systems can be powered by any suitable source(s). Power supply circuits can pass power through to solid state lights and can provide one or more of the functions disclosed herein, such as, but not limited to, current control, undervoltage protection (UVP), overvoltage protection (OVP), short circuit protection (SCP), over-temperature protection (OTP), etc. Dimming control signals, either or both wired and wireless, can be used to control the power supply circuits, including, for example, using isolated dimming inputs (e.g., 0 to 10 V, 0 to 3 V, digital, including wired and wireless including but not limited to those mentioned, discussed, listed, etc. herein, combinations of these, etc.) Other embodiments of the present invention can also monitor, log, store, access the web, the cloud, communicate with the Ethernet, mobile cellular carriers, etc., combinations of these, etc.

Implementations of the present invention can be futureproof. Various embodiments of the present invention are backward (and forward) compatible and can be completely interoperable with for example but not limited to existing energy management systems (EMS), building automation systems (BAS), including BACNET, Lon Net, etc., and can be used with different brands of equipment already installed. Embodiments of the present invention can also support demand response (DR) requests including load shedding by reducing the power to the respective lighting and other facilities, accessories, power consumers, etc. including the HVAC and also determining which areas, cubicles, are occupied or unoccupied. Embodiments of the present invention can respond to automated/automatic demand response (ADR) requests. In addition, embodiments of the present invention can determine the power consumption of the lighting and other electrical usage such as AC wall outlets, computers, personal and/or localized heaters, fans, air conditioners, etc. and combine and aggregate power usage by individuals, sub-groups, areas, locations, functions, floors, zones, sub-floors, buildings, campus, campuses, etc. Implementations of the present invention can receive, interpret, utilize, etc. signals generated for example but not limited electric utility companies, local, regional, national, etc. energy/power providers, etc. Such signal(s) can be used to not only turn off or dim/trim down the lighting of individual cubicles, groups of cubicles, and/or spaces, etc., combinations of these, etc. it can also turn down or, if necessary, off non-critical electrical operations and also decrease/turn down HVAC including but not limited to air conditioning while monitoring individual and group cubicles including the temperature, air quality, general environment, etc. of these cubicles. The present invention also allows for one, two, effectively any number of employees or inhabitants of cubicles to move to other similar cubicles and have their respective lighting profiles and preferences be transferred to that cubicle including by but not limited to electronically transferring the profile and preference information via connected computers and devices including but not limited via the cloud, the edge, the Ethernet, the Internet, servers, data centers, mobile/cellular phone carriers, etc., combinations of these, etc.

Some embodiments include one or more dimmers that can remotely set the minimum and maximum dimming levels, set local control, both remote and local control or local lockout, track the manual settings and changes, control, dim and monitor using one or more, for example, but not limited to phase cut dimming (forward, reverse and/or both, etc.), wired dimming including analog (i.e., 0 to 3 V, 0 to 10 V), digital (i.e., DALI, DMX, SPI, I2C, WiFi, BTLE, etc., combinations of these, etc.) and/or combinations of these, etc., wireless including, for example, but not limited to, RF and/or Optical/IR, etc. (i.e., ZigBee, LiFi, WiFi, Bluetooth, IrAD, Zwave, 6LoWPAN, LoRa, Thread, IPv4, IOv6, BTLE, cellular carriers, LTE, 1G, 2G, 3G, 4G, 5G, etc., combinations of these, etc.), PLC, etc., combinations of these, etc.

Embodiments of the present invention can monitor the power consumption/energy usage including by direct AC or DC line power, power to and through the lamps that are powered by other types of energy and power sources that can, for example, wired or wirelessly provide power, current, voltage, power factor, usage, energy consumed (i.e., kWH, etc.), etc. Such implementations of the present invention can also incorporate and use internal and/or external sensors including but not limited to light, motion, proximity, sonar, ultrasonic, radar, sound, voice, mechanical, daylight harvesting, combinations of these, etc.

Again, embodiments and implementations of the present invention can use one or both (e.g., combinations) of analog and/or digital dimming including hybrids or switching between, back and forth, from one to the other, etc. of analog and digital dimming and control. Embodiments of the present invention including the cubicle/personal space lighting and the other lighting such as ceiling, task, wall, desk lamp, emergency, etc., combinations of these, etc. can all be dimmed/controlled in the same or similar manner as well as all can be monitored for input and output power, current, voltage, power factor, harmonics, total harmonic distortion, etc.

Some embodiments of the dimmer control can use forward and/or reverse phase cut dimming, voltage and/or current dimming/reduction/etc.

Some embodiments of the present invention include a dimmer that allows for one or more buttons or other similar methods including but not limited to buttons, indents, etc. that allow other types of lighting such as but not limited to dimmable or on/off that are powered by other things including fans, heaters, furnaces, air conditions, humidifiers, etc. Such buttons, controls, etc. can also utilize light indicators including LED, OLED, QDs, etc. to show what is being controlled, acted on, etc.

As an example solid state lighting system with a dimmer implementing control and monitoring, communications with other devices, settings for lighting, sensors, etc., limits such as, but not limited to, dimming limits, storage, logging, tracking, lockout adjustment(s), etc. The dimmer can receive control signals, whether wired or wireless, from sources or systems such as, but not limited to, phase cut dimmers (forward and/or reverse), wired analog and/or digital controllers/monitors, any wireless sources, powerline communications (PLC) networks, etc. The solid state lighting system can also include one or more of any or all of light sensors, motion sensors, sound sensors, ultrasonic sensors, or other sensors. The system can include one or more light sources with wired and/or wireless control/dimming and/or monitoring, one or more AC phase controlled light(s) with control/dimming and/or monitoring, and one or more AC powered light(s) with wired and/or wireless and/or PLC control/dimming and/or monitoring as well as other lighting sources of any type or form including florescent lighting, solid state florescent lighting replacements (FLRs), incandescent, high intensity discharge, etc., outdoor lighting that can also optionally interact with the present invention.

The dimmer can also have dedicated remote control in addition to smart phone, tablet, computer, server, etc. control. Such a dimmer can have one or more additional switches and associated controls to provide on/off of input to ballasts etc. either locally or remotely. For example, but not limited to, a graphics user interface (GUI) can be installed on one or more desktop or laptop computers, or servers, etc. that permits, for example, but not limited to, dimming, trimming, color-changing, color temperature tuning, etc., combinations of these, etc. as well as optional monitoring, storing, data tracking, storage, mining, etc.

Embodiments of the present invention can use the solid state lighting power supply to power circuits in the solid state lighting power supply or any other desired load including but not limited to sensors, IOT, controls, communications, etc. including but not limited to those discussed herein, combinations of these, etc.

Voltage regulator(s) can be a linear regulator or can comprise a buck converter circuit or, in other embodiments, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc.

In some embodiments, an over-current protection circuit dither circuit, under-voltage protection, or any other control and protection signals and circuits can be used with the PWM control or other type of pulse control, including but not limited to over-temperature protection, over-voltage protection, etc.

One or more windings can be used to provide power to, for example, but not limited to, microcontroller(s) (etc.), communications radios (e.g., WiFi, ZigBee, Bluetooth, etc.) lights, sensors, detectors, IOT, controls, etc. The voltage feedback signal can be isolated or level shifted, for example by opto-isolator(s) to provide feedback to the PWM control circuit, enabling it to control the duty cycle on switch(es), thereby regulating voltage(s).

The solid state lighting dimmer can include an AC zero crossing circuit comprising voltage regulator and capacitors, resistors, AC opto-isolators, etc. The AC opto-isolator can be driven, for example by the AC input signal, so that the AC opto-isolator is turned off at zero crossings and otherwise is on.

The solid state lighting dimmer can also include a dimmer switch with back to back transistors driven by a PWM output signal to yield a dimming signal.

In some embodiments, the AC powered lighting, the FLRs, the POE, and/or other sources of powered lighting can have sensors in the solid state lighting system that have auxiliary ports that allow both control signals and other types of sensors, detectors, features, functions, etc. including, for example, but not limited to, motion, sound, video, vision recognition, pattern recognition, voice recognition, sound recognition, gesture, gesture recognition, etc., combinations of these, etc. The indoor and outdoor embodiments can be very similar except for being weather-proof for outdoor uses. Embodiments of the present invention can use existing lighting fixtures, including those with or without motion sensing and make them motion sensing capable including having the motion sensing inside the light source or as an extension to the light source that can be plugged into the light source and control the turning on/off and dimming up/down of the light source(s), etc., other sensors, alarms, alerts, communications, etc. can be added to embodiments of the present invention as well as being capable of being compatible with existing/legacy lighting including, for example, but not limited to motion detection, security, photoelectric cell/dusk to dawn lighting, etc., combinations of these, etc., including for example but not limited to, detecting when a conventional, non-communicating motion detector light fixture turns on and wirelessly or wire (or, in some cases, PLC) reporting, communicating, logging, tracking, etc. such information, etc. Embodiments of the present invention can also completely set all parameters of the present invention including but not limited to, the light level, detection threshold, detection level, distance, proximity, etc., notify under what conditions, notify neighbors, etc., light level to turn on at, whether to flash or not, etc., detection, sniffing, identification, etc. of smart devices including but not limited to smart phones, cellular phones, tablets, smart watches, wrist watches, fitness, well-being watches, PDAs, mobile devices, RFID, wearables, sounds, noise, voice(s), one or more certain frequencies, other types of technologies that can be used in tandem, conjunction with the present invention, other signatures, signs, identification, etc., combinations of these. Embodiments of the present invention can use such information to decide or aid in deciding whether the detection is due to, for example, but not limited to, a friend or foe and an unidentified source or object, person, animal, wind, etc. Embodiments of the present invention can record, store, analyze, keep track of, for example, the frequency of such occurrences and incidents, including any new digital, electronic, or other information including unique information about the device or person, etc. such as cellular phone identifiers, RF/wireless IDs, names, user names, etc. In addition, embodiments and implementations of the present invention can use optical or other methods to act as an intruder alert system such that, for example, but not limited to, an optical beam that connects two or more of the present invention including, examples where the two or more embodiments of the present invention have direct line of sight to each other and effectively have a beam of light in between that is broken or disrupted, etc. Such a beam of light can be modulated with the user able to select one or more from a variety of modulations so as to make it more difficult to emulate the beam, etc. Such beam modulations and detection can be two or more way so as to add to the reliability and security, etc. Embodiments of the present invention can also use daylight harvesting, light sensing etc.

Some embodiments of the solid state lighting system can be configured, controlled, monitored, etc., from/to smart devices using for example, but not limited to, Apps, laptops, desktops, servers, mobile and/or PDA devices of any type or form, combinations of these, etc.

Some embodiments include motion sensors performing multiple duties, such as, but not limited to, turning on/off lights, alerting that there are people there, heating or cooling spaces, burglar alarm, camera, image recognition, noise, voice, recognition, sound recognition, etc. accessories, thermal imagers, night vision, infrared cameras, infrared lit cameras, etc.

In some embodiments of the present invention, a small PWM pulse width can be the default pulse width such that the amount of power/current at the highest input voltage will limit the power applied without a signal to increase the pulse. This will allow a current/power limit in the event of, for example, a short circuit on the output since a small pulse to big pulse is needed for higher power in AC line voltage mode. The pulse width can be made larger by a circuit that measures the pulse width and allows the pulse width to increase until the desired current level is attained.

Some embodiments include motion sensors that can track, log, measure, determine, predict, guess, etc., the motion, the path, the direction, the way a person or persons or traffic, etc. will take, etc., can communicate including but not limited to wired, wirelessly, PLC, etc. to other units, people, computers, controllers, monitors, storage devices, human services, animal services, public services, police, fire, first responders, security personnel, family members, friends, guardians, etc.

Some embodiments include controllers with smart additional components, accessories, etc. Such controllers can use weather information, including from any source such as a local weather station, personal weather station, web-based weather report, etc. In some cases, weather is monitored locally, regionally, wind factor, have a wind indicator, etc., wind vane, wind generator, etc. Such controllers can also dim, flash, change intensities, white colors, be color-changing, etc., communicate two or more way, etc.

Some embodiments can use barcodes or scan codes, etc. for digital devices to read including app based codes that can be scan and read, for example, but not limited to, by a cell phone or a tablet, for example when provisioning a system with multiple FLRs.

All of the above can be seamlessly connected together and share, enjoy, use connectivity to communicate to one another. Any and all of the above can have two way communications including providing information on use, power use, current and voltage use, dimming, health, lighting health, sensor(s) settings and health, and readings, etc., power factor, efficiency, energy harvesting, harmonic distortion, total harmonic distortion, temperature, humidity, light, ambient conditions including both indoors and outdoors, other electrical, optical, mechanical, weather, etc. conditions, information, etc. Any and all of the embodiments of the present invention can be made weather-proof.

Some embodiments of the present invention can be used to treat, support, enhance, etc. health, to aid in treatment and recovery of ill, sick, injured individuals and groups including individuals and groups recovering or experiencing various physical and mental diseases and health issues.

Embodiments of the present invention are designed to be a cost-effective and complete solution that provides both forward and backward compatibility which is also ideal for retrofits and can use either wireless or wire (or both) communications.

Some embodiments of the present invention include comprehensive sensing and monitoring. Implementations of the present invention can be Web-based and/or WiFi-based (or other) and interface with smart phones, tablets, other mobile devices, laptops, computers, dedicated remote units, etc. and can support a number of wireless communications including, but not limited to, IEEE 802, ZigBee, Bluetooth, ISM, WiFi, sub-gigahertz, proprietary radio, other radio frequencies, other frequencies in the electromagnetic spectrum, other protocols, standards, interfaces, etc., combinations of these, etc.

Some embodiments of the present invention can include, but not limited to, dimmers, drivers, power supplies of all types, switches, motion sensors, light sensors, temperature sensors, daylight harvesting, other sensors, thermostats and more and can include monitoring, logging, analytics, etc.

Some embodiments of the present invention support and can include color changing, color tuning, etc. lights with numerous ways to interact with the lights.

Some embodiments of the present invention can be integrated with video, burglar, fire alarm, etc. components, systems.

Other features and functions include but are not limited to detecting the frequency using a microprocessor, microcontroller, FPGA, DSP, a transistor such as a field effect transistor (FET) such as a MOSFET or JFET to, for example, either turn on or turn off a circuit that operates in either ballast mode or AC line mode depending on the amplitude of the signal or with the inclusion of a time constant, the average, RMS, etc. voltage level.

Some embodiments of the present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

Some embodiments of the present invention provide two or more side (multi-side) lighting for example but not limited to, for the cubicle and/or for a FLR where one side contains SSL that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital (i.e., code red, code blue, code yellow, etc.), accent lighting, mood lighting, location indication, emergency information and direction, full spectrum lighting, etc.

The present invention can work with all types of communications devices including portable communications devices worn by individuals, walkie-talkie types of devices, etc.

The present invention can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters/leaders may transfer, transmit, or receive, etc. information, data, commands from other wireless and/or wired equipped fluorescent lamp replacements, etc. of combinations of these.

Some embodiments include one or more thermometers, thermostats, temperature controllers, temperature monitors, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy, WiFi, IEEE 801, IEEE 802, ZigBee, Zwave, other 2.4 GHz and related/associated standards, protocols, interfaces, ISM, sub-gigahertz, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, UART, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

In some embodiments of the present invention, the thermometer(s) and/or thermostats may be remotely located. In other embodiments of the present invention, such a temperature sensor or sensors or thermostat or thermostats can use wireless or wired units, interfaces. protocols, device, circuits, systems, etc. In some embodiments the thermometer(s) and/or thermostat(s) can communicate with each other and relay, share, augment, modify, interpret, add to, subtract from, and pass commands as well as provide information and data to one another. In some implementations of the present invention, the thermometer(s) and or thermostats can be located/incorporated into the embodiments of the present invention including the load switch lock including but not limited to wall switch lock.

In addition, some embodiments of the present invention can use switches that are remotely controlled and monitored to detect the use of power or the absence of power usage, to open or close garage or other doors by locally and/or remotely sending signals to garage door openers including acting as a switch to complete detection circuits, remembering the status of garage door opening or closing, working with other motion sensors, photosensors, daylight harvesters, ambient light sensors, other sensors, etc. horizontal/vertical detectors, inclinometers, etc., combinations of these, etc. Embodiments of the present invention can both control and monitor the status of the garage or other door and sound alarms, send alerts, flash lights including flashing white lights and/or one or more color/wavelength lights, turn on lights, turn off lights, activate cameras, record video, images, sounds, voices, respond to sounds, noise, movement, include and use microphones, speakers, earphones, headphones, cellular communications, etc., other communications, combinations of these, etc. Such embodiments and implementations can use Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc., relays, switches, transistors of any type and number, etc., combinations of these, etc.

Some embodiments support various types of radio frequency (RF) devices such as, but not limited to, window shades, drapes, diffusers, garage door openers, cable boxes, satellite boxes, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

Some embodiments include a global positioning system (GPS) to track the location and, for example, to also make decisions as to where and when the present invention should do certain things including but not limited to turning on or off, dimming, turn on heat or cooling, control and monitor the lighting, etc., control, water, monitor the lawn and other plants, trees etc.

Some embodiments of the present invention use/incorporate/include/etc. thermal imagers including but not limited to IR imagers, IR imaging arrays, non-contact temperature measurements including point temperature and array temperature measurements including in lighting such as the cubicle lighting of the present invention and T8, T12, T5, etc. FL replacements where the imagers are powered by, for example, but not limited to the ballast for the FLR and the AC line via a converter for AC line powered lighting.

Some embodiments allow for dimming with both ballasts of any type including but not limited to electronic and magnetic ballasts and AC line voltage.

Some embodiments can be used, for example, but not limited to, for daylight harvesting/vacancy and/or occupancy uses and applications.

Some embodiments use wireless signals to both control (i.e., dim) the personalized lighting including but not limited to the cubicle lighting and/or LED fluorescent lamp replacements (FLRs) and monitor the LED current, voltage and power. The present invention includes but is not limited to fluorescent lamp replacements that work directly with existing electronic ballasts and requires no re-wiring and can be installed in the same amount of time or less than changing a regular fluorescent lamp tube. These smart/intelligent SSL/LED FLRs and the cubicle lighting are compatible with daylight harvesting controls and protocols. Optional sensors allow for relative light output to be measured and wirelessly reported, monitored, and logged permitting analytics to be performed. Embodiments of the present invention come in a diversity of lengths including but are not limited to two foot and four foot T8 standard/nominal linear lengths as well as T12 as well as any other type of fluorescent and/or HID lamp including but not limited to those discussed herein. Additional optional input power measurements allow total power usage, power factor, input current, input voltage, input real and apparent power to also be measured thus allowing efficiency to be measured. The wireless signals can be radio signals in the industrial, scientific and medical (ISM), sub-gigahertz, etc. and/or ZigBee, ZWave, IEEE 802, or WiFi or Bluetooth or any type of form. In addition to occupancy/vacancy/motion sensors, photo sensors and daylight harvesting controls, simple and low cost interfaces that allow existing other brands, makes, and models of daylight harvesting controls, photo sensors, occupancy/vacancy/motion sensors to be connected to and control/dim embodiments of the wireless SSL/LED FLRs. The cubicle lighting and/or SSL FLR can be switched on and off millions of times without damage as well as be dimmed up and down without damage. The wireless communications can be encrypted and secure. Such embodiments of the present invention FLRs do not require or need a dimmable ballast and work with standard ballasts.

Some embodiments have integrated motion sensor(s) as part of the housing and can also use auxiliary motion sensors and can also have integrated light/photocell sensor as well as auxiliary. Such embodiments of the present invention can have the sensors discussed herein incorporated into the housing body or can have a cable or wireless connection to the sensors including having the one or more sensors mounted on the outside of the fixture, near the fixture or further away and more remote, etc. combinations of these, etc.

Some embodiments respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, any other type of sensor, detector, identifier, analog and/or digital ID, combinations of these including but not limited to those discussed herein, etc. In addition the present invention can be connected to fire alarms, fire alarm monitoring equipment, burglar and security protection service companies and services, health services, cable and/or satellite providers, internet providers, LTE, 1G, 2G, 2G, 4G, 5G, etc.

Some embodiments permit enhanced circadian rhythm alignment and maintenance using sources of light. Such sources of light include, but are not limited to, computer screens, monitors, panels, etc., tablet screens, smart phone screens, etc., televisions (TVs), LCD and CRT displays of any type or form, DVD and other entertainment lighting and displays containing LEDs, OLEDs, CCFLs, FLs, CRTs, etc., displays, monitors, TVs, OLED, LED, CCFL, FL, incandescent lighting, etc.

Some embodiments use smart phones, tablets, computers, dedicated remote controls, to provide lighting appropriate for circadian rhythm alignment, correction, support, maintenance, etc. that can be, for example, coordinated wake-up and sleep times whether on a ‘natural’ or shifted (i.e., night workers, shift workers, etc.) to set and align their sleep patterns and circadian rhythm to appropriates phases including time shifts and time zone shifts due to work and other related matters.

Some embodiments use external and internal information gathered from a number of sources including clocks, internal and external lighting, time of the year, individual, specific input, physiological signals, movements, monitoring of physiological signals, stimuli, including but not limited to, EEG, melatonin levels, urine, wearable device information, sleep information, temperature, body temperature, weather conditions, etc., combinations of these, etc.

Some embodiments use TVs essentially of any type or form, including, but not limited to smart TVs, and related and similar items, products and technologies including, but not limited to, computer and other monitors and displays that can either be remotely or manually controlled and, in some embodiments, monitored. The present invention can use smart phones, tablets, PCs, remote controls including programmable remote controls, consoles, etc., combinations of these etc., to control and set the content of the lighting (e.g., white or blue-enriched, etc. combinations of these, etc. for wake-up; yellow, amber, orange, red, etc., combinations of these, etc. for sleep-time, etc.) automatically to assist in circadian rhythm, sleep, SAD mitigation, reduction, elimination, etc. In some embodiments of the present invention, music, sounds, white noise, sea shore sounds, sound effects, narratives, live audio, inspirational audio including previously recorded, generated, synthesized, etc., soothing sounds, familiar sounds and voices, etc. and combinations of these to go to sleep with. Jarring, buzzing, alarming, beeping, interrupting sounds, alarm clock sounds and noises, sleep disruptive sounds, noises and/or voices, etc. accompanied by white light, blue color/wavelength light including, but not limited to, slowing dimming up to a preset, optimum, and/or maximum brightness or setting, etc. for wake-up in the morning. Embodiments of the present invention can provide multiple wake-ups to the same location and/or different locations including other locations in homes, houses, hotels, hospitals, dormitories including school and military and other types of barracks, dormitories, etc., assisted living homes and facilities, chronic care facilities, rehabilitation facilities, etc., children's hospitals and care facilities, etc. group living, elder living, etc., children's rooms and other family members whether in the same physical location or in different physical locations, friends and family, clients, guests, travelers, jet lagged and sleep deprived people and personnel, etc.

Some embodiments respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, etc. In addition the present invention can be connected to fire alarms, fire alarm monitoring equipment, home and/or business monitoring, protection services and companies, etc.

Some embodiments use a BACNET to wireless converter box or BACNET to a wired or wireless device including but not limited to Bluetooth including Bluetooth low energy (BLE), WiFi, Zigbee, Thread, 6LowPAN, DALI, DMX, 0 to 10 V, etc., combinations of these, etc. The present invention can also use infrared signals to control and dim the lighting and other systems as well as other types of devices including but not limited to heating and cooling, thermostats, on/off switches, other types of switches, etc.

Some embodiments include a motion proximity sensor that sends signals back to the controller/monitor or other devices including but not limited to cell phones, smart phones, tablets, computers, laptops, servers, remote controls, etc. when motion or proximity is detected etc. Embodiments of the present invention can have on/off switches for the ballasts where the ballasts connect to the AC lines and/or also where the ballasts connect to the present invention, etc.

Embodiments and implementations of the present invention allow for optional add-ons including but not limited to field installable add-ons and/or upgrades including but not limited to hardware, firmware, software, etc., combinations of these, etc. including but not limited to wired, wireless or powerline control to be added later and interfaced to the present invention as well as allowing sensors such as daylight harvesting/photo/light/solar/etc. sensors as well as motion/PIR/proximity/other types of motion, distance, proximity, location, etc., sensors, detectors, technologies, etc., combinations of these, etc. to be used with the present invention.

The present invention provides a means to improve circadian rhythm by providing the appropriate wavelength and/or wavelengths of light at appropriate times.

Some embodiments include internal and external photosensors including wavelength specific or the ability to gather entire or partial spectrum, etc. and can use atomic clock(s) signals, other broadcast time signals, cellular phone, time, smart phone, tablet, computers, personal digital assistants, etc., remote control via dedicated units, smart phones, computers, laptops, tablets, etc.

Some embodiments include some or all of sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., cameras of any type and form including but not limited to one or more and more than one each of security cameras, infrared cameras, web cam (cameras), closed circuit cameras, etc., combinations of these, etc. The sound and/or noise sensors as well as other sensors, etc. can use one or more filters including one or more low pass, high pass, notch, bandpass including narrow bandpass filters, etc. Such filters can be realized by either or both analog and digital means, approaches, ways, functions, circuits, etc., combinations of these, etc. Such filter functions can be either active or passive or both, can be manually and/or automatically set and adjustable, can be set, adjusted, programmed, etc. by an app, by other types and forms of software and hardware, by smart phone(s), tablet(s), laptops, servers, computers, other types of personal digital assistant(s), etc.

Embodiments of the present invention can have more than one wavelength or color of LEDs and/or SSLs and can include more than one array of LEDs, OLEDs, QDs, etc. that permit color selection, color blending, color tuning, color adjustment, etc. Embodiments of the present invention can include multiple arrays that can be switched on or off or in or out and/or dimmed with either power being supplied by a ballast or the AC line that can be remotely selected, controlled and monitored. Examples of the present invention include different wavelengths, combinations of colors and phosphors, etc. are used to obtain desired performance, effects, operation, use, etc. Embodiments can include one, two, three or more arrays of SSLs, including, but not limited to, side-by-side, 180 degrees from each other, on opposite sides, on multiple sides for example hexagon or octagon, etc. The SSLs including but not limited to LEDs, OLEDs, QDs, etc. may be put in series, parallel or combinations of series and parallel, parallel and series, etc. In other embodiments of the present invention, phosphors, quantum dots, and other types of light absorbing/changing materials that for example can effectively change wavelengths, colors, etc. for example by applying a voltage bias or electric field.

Embodiments of the present invention may use an insulating housing made from, for example but not limited to, glass or an appropriate type of plastic, which may or may not have a diffuser or be a diffuser in terms of the plastic. In some embodiments of the present invention plastic housings may be used that can include diffusers on the entire surface, diffusers on half the surface, diffusers on less than half the surface, diffusers on more than half of the surface, with the rest of the surface either being clear plastic, opaque plastic or a metal such as aluminum or an aluminum alloy.

Photon/wavelength conversion including down conversion can be used with the present invention including being able to adjust the photon/wavelength conversion electrically. Spectral/spectrum sensors can be used to detect the light spectral content and adjust the light spectrum by turning on or off certain wavelengths/colors of SSL. The spectral sensors could consist of color/wavelength sensitive detectors covering a range of colors/wavelengths of filters that only each only permit a certain, typically relatively narrow, range of wavelengths to be detected. As an example, red, orange, amber, yellow, green, blue, etc. color detectors could be included as part of the spectral/spectrum sensor or sensors. In some embodiments of the present invention, quantum dots can be used as part of and to implement the spectral/spectrum sensors. SSL including but not limited to the LED, OLED, and/or QD lighting may use phosphor converted (PC) technologies, techniques, etc. and may be QC-based products, etc. In addition, microLEDs and related devices, technologies, techniques, approaches, etc. including PC-microLEDs may be used with and incorporated into embodiments and implementations of the present invention, etc.

Some embodiments and implementations of the present invention can set user requirements, password priorities, permission levels, etc. for all or parts of the system including down to the individual lamp/bulb level which can/may be controlled, managed at a central or distributed level and can use mesh techniques to propagate information, commands, passwords, authentications, etc.

Some embodiments include and consist of any number and arrangement of smart dimmers (by wired, wireless, powerline communications, etc. combinations of these, etc.) including ones that connect directly to the AC power lines that can control, but are not limited to, one or more of, for example, but not limited to, as an example, FLRs, A-lamps, PAR 30, PAR 38, PLC lamps, R20, R30, MR16, track lighting, low voltage lighting including but not limited to legacy incandescent and halogen lighting as well as SSL/LED replacement lighting, dimmable compact florescent lamps, incandescent bulbs, halogen bulbs, etc. as well as smart dimmable (i.e., by wired, wireless, powerline communications, etc., combinations of these, etc.), infrared controlled devices including lighting of any type and form including dimmable and/or color-changing, color temperature (CCT) changeable/tunable lighting of any type and form, etc., heaters of any type or form, air conditioners of any type or form, color-changing, color-tunable, white color-changing, lighting of any type including but not limited to those discussed herein. Non-dimmable lamps and appliances and entertainment device can also be included in such implementations of the present invention and may be turned on and off by one or more of the smart on/off switches or a dimmer that is, for example, but not limited to, programmed to full on and full off only, etc. Such implementations of the present invention can also use one or more or all of the sensors, detectors, processes, approaches, etc. discussed herein and well as any other type or types of sensors, detectors, controls, etc. The smart lighting, dimmers, power supplies, sensors, controls, etc. can use any type or types of wired, wireless, and/or powerline communications. Any practical number of dimmers, lights, lighting, sensors, detectors, controls, monitoring, logging, analytics, heaters, air conditioners, fire, safety, burglar alarm(s), burglar protection, etc., appliances, entertainment devices, home safety, personal safety, thermometer(s), thermostat(s), humidifier(s), clock(s), including clock(s) of any type and form, timer(s), vents, registers, etc. for residential, home, and business HVAC, televisions, radios, stereos, printers, other office equipment and appliances, projectors including projectors for display video information, data, movies, word processing, presentations, including but not limited to power point presentations and PDF files, etc., other audio-visual equipment, accessories, components, including but not limited to screens, screens that can be lowered, raised, rolled up, etc. using electromechanical ways, methods, techniques, technologies, etc. including but not limited to motors, displays including computer monitors and smart TVs including ones with remote control capability such as an IR remote control, solar devices including but not limited to solar panels, inverters and converters for solar power generation, microgrids, minigrids, off-grid, grid power, back-up power, solar blankets, solar curtains, solar windows including but not limited to smart solar windows, solar drapes, solar blinds, etc. including but not limited to smart and intelligent solar systems, devices, components, etc.

The present invention provides for lighting that is highly configurable, controllable, customizable, sensor-rich, energy communication devices and can include, among other things, but not limited to, voice command, improved security and energy savings.

Some embodiments can make buildings or all types, forms, uses, including but not limited to residential and commercial, smarter, more energy efficient with the sensors, SSL/LED lights, and controllers and other embodiments of the present invention that allow, for example, but are not limited to integrating the present invention into existing building energy management systems.

Some embodiments of the present invention enable different kinds/types of smart, intelligent lighting to be incorporated including but not limited to daylight harvesting to prevent needless use of over lighting of sunlit and other externally artificially lit rooms and extend bulb life coupled with simple, easy installation through, for example, but not limited to, plug-and-play, constant-lumens technology. In parking lots, the present invention will prevent needless over-lighting of these by using one or more of occupancy, vacancy, ultrasonic, sonar, radar, noise, vision recognition, camera analysis, data mining, pattern recognition, etc., web cams, security cameras, inspection cameras, etc., motion sensors, etc. to ensure the parking lot or the path through the parking lot is well lit when and where it needs to be, and save energy by dimming or even turning off lights when they are not needed. Embodiments of the present invention will also help to create controllable lighting environments with adaptive and color-changing, color tuning lights that help students from elementary through professional/graduate school learn, focus, stay attentive and awake or rest when and where needed. Other embodiments of the present invention include controllable lighting for human centric, hospitals, laboratories and emergency applications and situations including but not limited to high quality health care, light therapy, light centric medical and health and healing applications, patient ability to adjust, control and be better with proper lighting, etc.

Some embodiments of the present invention can improve security and performance while saving energy and money as well as the lighting having a dramatic positive effect in improving the appearance including but not limited to lights that can change color to suit mood, dim when no one is around and turn on when motion or noise is detected.

Some embodiments include but are not limited to intelligent lighting solutions related to the control, communication, analytics, sensing and monitoring technologies that can fundamentally change the power consumption and utility of lighting systems Embodiments of the present invention can use the lights to collect a wide variety of sensor information that can be used for, for example, but are not limited to, enhancing energy savings to improving security and efficiency.

Some embodiments of the present invention allow for automatic and/or manual dimming coupled with monitoring ambient light and intelligently auto-dims in response. Dim level can also be adjusted manually or automatically including but not limited to timing, sequencing, synchronizing, etc.

Some embodiments of the present invention allow for Plug-and-Play by for example but not limited to replacing fluorescent lamps (compact, PLC, and/or linear, etc.) with SSL/LED technology is as easy as plug-and-play—no re-wiring or ballast change required making your retrofit easy and cost effective with embodiments of the present invention that can also be directly powered by AC or DC. Embodiments of the present invention allow for the lighting to be accessed on the individual lamp level through, for example, but not limited to, Bluetooth and WiFi communication pathways

Some embodiments of the present invention allow for the SSL/LED power supply and driver to produce constant lumen SSL/LED output regardless and independent of type of ballast or lack of presence of ballast (i.e., can be wired directly to AC or DC power). Embodiments of the present invention allow for two way communication with the lighting using, for example, but not limited to, computer software, servers, tablets, smartphones, or local manual controls. Some embodiments of the present invention can include and/or work with cybersecure interfaces and protocol.

In some embodiments, the operational lifetime of the SSL/LED lighting can be significantly extended with auto dimming Unlike incandescent or fluorescent lighting, the lifetime of LEDs is not shortened by frequent switching or thermal cycles.

Some embodiments of the present invention can be configured to have autonomous control with each sensor or group of sensors interacting with the lighting autonomously, or other implementations of the present invention can be integrated into energy management systems to maximize energy savings and enhance the work environment, while providing detailed analytics and monitoring, including for marine and shipboard applications.

Some embodiments of the present invention can be tuned to wavelengths that are important to the health of employees, patients or customers. Specific wavelengths can aid in Seasonal Affective Disorder (SAD) and help regulate circadian rhythms for better sleeping.

Some embodiments of the present invention can be solar friendly and used with low-voltage DC, line-voltage AC or DC sockets, and ballasts without requiring power converters.

The control systems can also communicate with one or more gateways, or aggregators, accumulators, servers, loggers, etc. that can communicate among the fluorescent lamp replacements, the sensors, themselves, to other servers including but not limited to a central server, a laptop, a desktop, other devices including but not limited to smart phones, tablets, personal digital assistants, mobile carriers, cloud-based systems, WiFi networks, etc.

Based upon the disclosure herein, one of skill in the art will recognize that any number or combination of control circuits in switch locks in any variation can be networked or connected with control systems, gateways, remote sensors, peripherals, networks, etc. in an endless variety of configurations based upon the application and requirements. This includes having more than one smart lamp, one of more follower lamps that accept a dimming signal (which could be analog, digital or both or of any other type) and respond accordingly.

The switch locks can include wireless RF and/or IR links, and, in some embodiments, wired and/or PLC connections, and can be controlled by wireless controllers or interpreters such as those disclosed in PCT patent application PCT/US15/12965 filed Jan. 26, 2015 for “Solid State Lighting Systems”, and can be powered by power supplies such as, but not limited to, supplies such as that disclosed in U.S. patent application Ser. No. 13/674,072, filed Jun. 2, 2013 for a “Dimmable LED Driver with Multiple Power Sources”, which are incorporated herein by reference for all purposes. Embodiments of the present invention can, in general, include one or more of wired, wireless, powerline control including either or both AC and/or DC powerline control.

Embodiments of the present invention can have independent but coordinated modular control and can also in some implementations of the present invention interface, or connect with ceiling-based or task-based lighting wired and/or wirelessly and/or by PLC.

Embodiments of the present invention provide a higher degree of personalized control over the lighting and other related functions, systems, components, operations, including but not limited to HVAC, acoustics, entertainment, infotainment, other environmental controls, etc., combinations of these, etc. in an individual's environment.

Implementations of the present invention can integrate with a variety of controls, from dedicated hardware controls (e.g., dimmer switch) to mobile devices, computers, remote software and servers, and building management systems including but not limited to the ability to integrate with a variety of sensors, including but not limited to daylight harvesting, motion, temperature, carbon dioxide, etc. cameras, surveillance, security, IOT, others discussed herein, combinations of these, etc. The present invention also can integrate with databases, timers, and clocks to, for example but not limited to, allow color tuning over time in the correct time zone, scheduled performance, responses, etc. The present invention can even (i.e., make uniform) light output on a work surface (higher light output for farthest portion of surface) so that all parts of the surface have equal light output and also employ other forms of optical engineering to achieve this.

Remote dimming can be performed using a controller implementing occupancy or vacancy detection, recognizing occupancy, vacancy, or proximity to a detector or sensor and setting a dimming level in response to the detected occupancy, vacancy, or proximity, or with audio detection, for example detecting sounds or verbal commands to set the dimming level in response to detected sounds, volumes, or by interpreting the sounds, including voice recognition or, for example, by gesturing including hand or arm gesturing, etc. Some embodiments may be dual dimming, supporting the use of a 0-10 V dimming signal in addition to a Triac-based or other phase-cut or phase angle dimmer. Some embodiments of the present invention may multiple dimming (i.e., accept dimming information, input(s), control from two or more sources). In addition, the resulting dimming, including current or voltage dimming, can be either PWM (digital) or analog dimming or both or selectable either manually, automatically, or by other methods and ways including software, remote control of any type including, but not limited to, wired, wireless, voice, voice recognition, gesturing including hand and/or arm gesturing, pattern and motion recognition, PLC, RS232, RS422, RS485, SPI, I2C, universal serial bus (USB), UART, Firewire 1394, DALI, DMX, including other implementations of DMX including but not limited to DMX512, etc. Voice, voice recognition, gesturing, motion, motion recognition, etc. can also be transmitted via wireless, wired and/or powerline communications (PLC) or other methods, etc. In some embodiments of the present invention speakers, earphones, microphones, etc. may be used with voice, voice recognition, sound, etc. and other methods, ways, approaches, algorithms, etc. discussed herein.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention, although described in some ways primarily for occupancy, vacancy, proximity, and light/photodetection control, can and may also use other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

Some embodiments include RFID or other identification of authorized persons, such as, but not limited to, workers, employees, facilities personnel and managers, first responders such as police, fire department personnel, paramedics, nurses, doctors, other emergency personnel, etc. Embodiments of the present invention can use, for example, but not limited to, RFID worn by individuals to identify and select settings including but not limited to, lighting settings and priorities, hierarchies, etc., combinations of these, etc. based on the individual/personal/etc. RFIDs to, for example, respectively set, turn on, dim, turn off, etc. certain lighting (levels), etc. as well as other settings and functions such as entertainment (radio, music, TV, etc.) settings, bed settings, alert settings which could also be coupled to the time of day, day of the week, weather, ambient temperature, ambient lighting, etc., combinations of these, etc. As a non-limiting example, when a person with a certain profile enters a room, certain lights will turn on to a certain preset level, when a different person with a different profile and potentially different permission levels enters the same room, the light levels may be set to change to a different value or values, when a custodial service member enters the room, the lights may be set to a different level, color temperature, color or colors, etc. including depending on the time or day (or night). The lights and other items can also respond to an emergency including flashing or becoming brighter, more intense, changing color. Embodiments of the present invention can also respond to different priority levels, authority levels, emergencies, personnel, etc.

Some embodiments of the present invention can be vacancy and/or occupancy sensing capability.

Some embodiments include a dimmer that also can turn off ballasts for example, but not limited to, for example, turning off/switching off/disconnecting the power to a ballast when, for example, a low dimming/fully off, etc. point/signal is reached.

Some embodiments support calibration, including self-calibration including but not limited to, calibration of light intensity, daylight harvesting, parameters, parametric performance and calibration including but not limited to agency, certifications, etc.

Some embodiments advertise, broadcast and obtain Bluetooth and other ID, identification, information, etc.

Some embodiments use display panels including but not limited to OLED panels, tablets, etc. as lighting panels.

Some embodiments a synchronous bridge for dimmers, and can have a Triac that is, for example, but not limited to being in parallel with the diodes and transistors of embodiments of the present invention.

Some embodiments provide motion sensing for either outdoor or indoor that can wirelessly, wired and/or powerline communications set, program, control, monitor, log, respond, alert, alarm, etc. including being able to be part of a cluster, group, community of lights, etc., that provides, for example, but not limited to, protection and security, etc., can, for example, but not limited to, detect a defective light, light (burned) out, can provide dimming, can use one or more colors of white, RGB, etc., can dim up and dim down, etc., Can control, set, program, sequence, synchronize, etc. all parameters including but not limited to distance, length of time on, sensitivity, ambient light level, response, synchronizing with outdoor and indoor motion sensors, response including but not limited to white color temperature and/or color choice(s), flashing or solid on, flashing, sequences of flashing, sequences of flashing and solid on, etc. of one or more colors including but not limited to one or more white colors, one or more white colors with one or more other colors, one or more colors,

Some embodiments includes sensors in the light(s), sensors attached to and/or near the light(s), sensors remote from the lights including battery powered, AC powered, solar powered, energy harvested, battery charged, etc., combinations of these, etc., including, for example, but not limited to, solar power battery charging. Implementations of the present invention can use high efficiency power supplies including but not limited to AC to DC, DC to DC, etc. to power the sensors, etc.

Some embodiments include sound making devices at doors, such as external entry doors, stairwells, etc. enabling audio detectors in or associated with FLRs to hear the sound and turn on lights. Various embodiments can use any device, approach, method, etc. that can convey that the door is opened or someone has passed through the door including, for example, but not limited to, photoelectric beam and photoelectric eye, magnetic proximity switch, other types of detection of open door, etc., can use two tone or more tone frequency, etc.

Some embodiments use active or passive or both high pass, low pass, bandpass, notch, other filters, combinations, etc. including with the voice, sound, noise detection.

Some embodiments use isolated digital PWM that can be converted to analog near the control reference point.

Some embodiments use proximity and/or signal strength to decide, for example, but not limited to turn on or off lights, etc.

Some embodiments flash lights at the end of an allotted time, for example to indicate that the next group is ready to use, for example, a conference room.

Some embodiments listen for and respond to emergency sounds such as smoke, fire, CO, etc. detectors, sensors, etc. by flashing, turning on, forwarding the information, alert, alarm, etc.

Some embodiments are powered over Ethernet (POE), dimmed, controlled, monitored, logged, two way communicated with, data mined, analytics, etc. Can be powered, controlled, monitored, managed, etc. via wired or wireless or powerline control (PLC) including but not limited to serial communications, parallel communications, RS232, RS485, RS422, RS423, SPI, I2C, UART, Ethernet, ZigBee, Zwave, Bluetooth, BTLE, WiFi, sub-gigahertz, cellular, mobile, ISM, Wink, powerline, etc., combinations of these, etc.

Some embodiments of the present invention can interact, support, control, be controlled by social media including but not limited to Facebook, Twitter, Snapshot, Snapchat, Linkedin, local, neighborhood websites and bulletin board, Nextdoor, Yelp, Next Door, Angie's List, You Tube, LinkedIn, Flickr, Tumblr, e-mail, etc., combinations of these, etc. Embodiments of the present invention can also recognize the siren/alarm of a smoke detector, carbon monoxide detector, etc., combinations of these, etc.

Some embodiments of the present invention can use face and/or gesture recognition to turn on the lights, dim the lights, etc.

Some embodiments of the invention can be configured, controlled, monitored, etc., from/to smart devices using for example, but not limited to, Apps, laptops, desktops, servers, mobile and/or PDA devices of any type or form, combinations of these, etc.

Some embodiments of the invention can include motion sensors performing multiple duties—turning on/off lights, alerting that there are people there, heating or cooling spaces, burglar alarm, camera, image recognition, noise, voice, recognition, sound recognition, etc. accessories, thermal imagers, night vision, infrared cameras, infrared lit cameras, etc.

Implementations of the present invention include comprehensive sensing and monitoring. Implementations of the present invention can be Web-based and/or WiFi-based (or other) and interface with smart phones, tablets, other mobile devices, laptops, computers, dedicated remote units, etc. and can support a number of wireless communications including, but not limited to, IEEE 802, ZigBee, Bluetooth, ISM, etc.

Implementations of the present invention can include, but not limited to, dimmers, drivers, power supplies of all types, switches, motion sensors, light sensors, temperature sensors, daylight harvesting, other sensors, thermostats and more and can include monitoring, logging, analytics, etc.

Embodiments of the present invention support and can include color changing, color tuning, etc. lights with numerous ways to interact with the lights.

Embodiments of the present invention can be integrated with video, burglar, fire alarm, etc. components, systems.

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

The present invention can work with all types of communications devices including portable communications devices worn by individuals, walkie-talkie types of devices, etc.

The present invention can use combinations of wireless and wired interfaces to control and monitor; for example for one or more of the cubicle and/or personal lighting and/or one or more linear or other fluorescent replacement for, for example, but not limited to, T4, T5, T8, T9, T10, T12, etc., one (or more) of the replacement lamps can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters/leaders may transfer, transmit, or receive, etc. information, data, commands from other wireless and/or wired equipped fluorescent lamp replacements, etc. of combinations of these.

The present invention can also have one or more thermometers, thermostats, temperature controllers, temperature monitors, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, UART, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

In some embodiments of the present invention, the thermometer(s) and/or thermostats may be remotely located. In other embodiments of the present invention, such a temperature sensor or sensors or thermostat or thermostats can use wireless or wired units, interfaces. protocols, device, circuits, systems, etc. In some embodiments the thermometer(s) and/or thermostat(s) can communicate with each other and relay, share, and pass commands as well as provide information and data to one another.

In addition, embodiments of the present invention can use switches that are remotely controlled and monitored to detect the use of power or the absence of power usage, to open or close garage or other doors by locally and/or remotely sending signals to garage door openers including acting as a switch to complete detection circuits, remembering the status of garage door opening or closing, working with other motion sensors, photosensors, etc. horizontal/vertical detectors, inclinometers, etc., combinations of these, etc. Embodiments of the present invention can both control and monitor the status of the garage or other door and sound alarms, send alerts, flash lights including flashing white lights and/or one or more color/wavelength lights, turn on lights, turn off lights, activate cameras, record video, images, sounds, voices, respond to sounds, noise, movement, include and use microphones, speakers, earphones, headphones, cellular communications, etc., other communications, combinations of these, etc. Such embodiments and implementations can use Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, 1 to 10 Volt, etc., relays, switches, transistors of any type and number, etc., combinations of these, etc.

The present invention also allows various types of radio frequency (RF) devices such as, but not limited to, window shades, drapes, diffusers, garage door openers, cable boxes, satellite boxes, cable communications, satellite communications, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

Embodiments of the present invention can use/incorporate/include/etc. thermal imagers including but not limited to IR imagers, IR imaging arrays, non-contact temperature measurements including point temperature and array temperature measurements including in lighting such as T8 replacements where the imagers are powered, for example, but not limited to the ballast.

Embodiments of the present invention allow for dimming with both ballasts and AC line voltage.

Implementations of the present invention can use, but are not limited to, Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

Embodiments of the present invention include SSL/LED Direct Fluorescent Tube Lamp Replacements that can be used, for example, but not limited to, for daylight harvesting/occupancy uses and applications.

Some embodiments of a switch lock include circuits that use wireless signals to both control (i.e., dim) the SSL including but not limited to the cubicle and/or personal lighting and/or the SSL/LED fluorescent lamp replacements (FLRs) and monitor the LED current, voltage and power. The present invention includes but is not limited to fluorescent lamp replacements that work directly with existing electronic ballasts and requires no re-wiring and can be installed in the same amount of time or less than changing a regular fluorescent lamp tube. These smart/intelligent LED FLRs are compatible with most daylight harvesting controls and protocols. Optional sensors allow for relative light output to be measured and wirelessly reported, monitored, and logged permitting analytics to be performed. Embodiments of the present invention come in a diversity of lengths including but are not limited to two foot and four foot T8 standard/nominal linear lengths as well as T12 and also other types such as T10, T9, T4, PLC, PL, 2 pin, 4 pin, compact florescent, including different lengths, shapes, and sizes such as U-bend, linear, tubular, multi-tubes, of any diameter, size, length, shape. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or ZigBee, ZWave, IEEE 802, or WiFi or Bluetooth or any type of form. In addition to occupancy/motion sensors, photo sensors and daylight harvesting controls, simple and low cost interfaces that allow existing other brands, makes, and models of daylight harvesting controls, photo sensors, occupancy/motion sensors to be connected to and control/dim embodiments of the wireless SSL/LED FLRs. The SSL FLR can be switched on and off millions of times without damage as well as be dimmed up and down without damage. The wireless communications can be encrypted and secure. Such embodiments of the present invention do not require or need a dimmable ballast when using the FLRs.

The present invention can have integrated motion sensor as part of the housing and can also use auxiliary motion sensors and can also have integrated light/photocell sensor as well as auxiliary.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, etc., others mentioned herein, etc., combinations of these, etc. In addition the present invention can be connected to fire alarms, fire alarm monitoring equipment, etc.

Embodiments of the present invention permits enhanced circadian rhythm alignment and maintenance using sources of light. Such sources of light include, but are not limited to, computer screens, monitors, panels, etc., tablet screens, smart phone screens, etc., televisions (TVs), LCD and CRT displays of any type or form, DVD and other entertainment lighting and displays containing LEDs, OLEDs, CCFLs, FLs, CRTs, etc., displays, monitors, TVs, OLED, LED, CCFL, FL, incandescent lighting, etc.

The present invention can use smart phones, tablets, computers, dedicated remote controls, to provide lighting appropriate for circadian rhythm alignment, correction, support, maintenance, etc. that can be, for example, coordinated wake-up and sleep times whether on a ‘natural’ or shifted (i.e., night workers, shift workers, etc.) to set and align their sleep patterns and circadian rhythm to appropriates phases including time shifts and time zone shifts due to work and other related matters. Embodiments of the present invention can use, generate, respond to scenes, scheduling, synchronization, coordination, etc.

The present invention can use external and internal information gathered from a number of sources including clocks, internal and external lighting, time of the year, individual, specific input, physiological signals, movements, monitoring of physiological signals, stimuli, including but not limited to, EEG, melatonin levels, urine, wearable device information, sleep information, temperature, body temperature, weather conditions, etc., combinations of these, etc.

The present invention can use TVs essentially of any type or form, including, but not limited to smart TVs, and related and similar items, products and technologies including, but not limited to, computer and other monitors and displays that can either be remotely or manually controlled and, in some embodiments, monitored. The present invention can use smart phones, tablets, PCs, remote controls including programmable remote controls, consoles, etc., combinations of these etc., to control and set the content of the lighting (e.g., white or blue-enriched, etc. combinations of these, etc. for wake-up; yellow, amber, orange, red, etc., combinations of these, etc. for sleep-time, etc.) automatically to assist in circadian rhythm, sleep, SAD mitigation, reduction, elimination, etc. In some embodiments of the present invention, music, sounds, white noise, sea shore sounds, sound effects, narratives, live audio, inspirational audio including previously recorded, generated, synthesized, etc., soothing sounds, familiar sounds and voices, etc. and combinations of these to go to sleep with. Jarring, buzzing, alarming, beeping, interrupting sounds, alarm clock sounds and noises, sleep disruptive sounds, noises and/or voices, etc. accompanied by white light, blue color/wavelength light including, but not limited to, slowing dimming up to a preset, optimum, and/or maximum brightness or setting, etc. for wake-up in the morning. Embodiments of the present invention can provide multiple wake-ups to the same location and/or different locations including other locations in homes, houses, hotels, hospitals, dormitories including school and military and other types of barracks, dormitories, etc., assisted living homes and facilities, chronic care facilities, rehabilitation facilities, etc., children's hospitals and care facilities, etc. group living, elder living, etc., children's rooms and other family members whether in the same physical location or in different physical locations, friends and family, clients, guests, travelers, jet lagged and sleep deprived people and personnel, etc.

The present invention can have integrated motion sensor as part of the housing and can also use auxiliary motion sensors and can also have integrated light/photocell sensor as well as auxiliary. In some embodiments of the present invention, these can be used for either or both the cubicle/personal lighting and be stand-alone units that replace conventional fluorescent lamps including, but not limited to, T8, T12, T5, T10, T9, U-shaped, CFLs, etc. of any length, size and power as well as high intensity discharge lamps of any size, type, power, etc.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, etc. In addition the present invention can be connected to fire alarms, fire alarm monitoring equipment, etc.

The present invention can use a BACNET to wireless converter box or BACNET to Bluetooth including Bluetooth low energy (BLE) converter. The present invention can also use infrared signals to control and dim the lighting and other systems as well as other types of devices including but not limited to heating and cooling, thermostats, on/off switches, other types of switches, etc.

The present invention can have the motion proximity sensor send signals back to the controller/monitor or other devices including but not limited to cell phones, smart phones, tablets, computers, laptops, servers, remote controls, etc. when motion or proximity is detected etc. Embodiments of the present invention can have on/off switches for the ballasts where the ballasts connect to the AC lines and/or also where the ballasts connect to the present invention, etc.

Embodiments and implementations of the present invention allow for optional add-ons including but not limited to wired, wireless or powerline control which, for example, could be installed or added later and interfaced to the present invention as well as allowing sensors such as daylight harvesting/photo/light/solar/etc. sensors as well as motion/PIR/proximity/other types of motion, distance, proximity, location, etc., sensors, detectors, technologies, etc., combinations of these, etc. to be used with the present invention.

The present invention provides a means to improve circadian rhythm by providing the appropriate wavelengths of light at appropriate times.

Internal and external photosensors including wavelength specific or the ability to gather entire or partial spectrum, etc. and can use atomic clock(s) signals, other broadcast time signals, cellular phone, time, smart phone, tablet, computers, personal digital assistants, etc., remote control via dedicated units, smart phones, computers, laptops, tablets, etc.

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc. The sound and/or noise sensors as well as other sensors, etc. can use one or more filters including one or more low pass, high pass, notch, bandpass including narrow bandpass filters, etc. Such filters can be realized by either or both analog and digital means, approaches, ways, functions, circuits, etc., combinations of these, etc. Such filter functions can be active or passive or both, can be manually and/or automatically set and adjustable, can be set, adjusted, programmed, etc. by an app, by other types and forms of software and hardware, by smart phone(s), tablet(s), laptops, servers, computers, other types of personal digital assistant(s), etc.

Embodiments of the present invention can have more than one wavelength or color of LEDs and/or SSLs and can include more than one array of LEDs, OLEDs, QDs, etc. that permit color selection, color blending, color tuning, color adjustment, etc. Embodiments of the present invention can include multiple arrays that can be switched on or off or in or out and/or dimmed with either power being supplied by a ballast or the AC line that can be remotely selected, controlled and monitored. Examples of the present invention include different wavelengths, combinations of colors and phosphors, etc. are used to obtain desired performance, effects, operation, use, etc. Embodiments can include one, two, three or more arrays of SSLs, including, but not limited to, side-by-side, 180 degrees from each other, on opposite sides, on multiple sides for example hexagon or octagon, etc. The SSLs including but not limited to LEDs, OLEDs, QDs, etc. may be put in series, parallel or combinations of series and parallel, parallel and series, etc. In other embodiments of the present invention, phosphors, quantum dots, and other types of light absorbing/changing materials that for example can effectively change wavelengths, colors, etc. for example by applying a voltage bias or electric field. The present invention can also take the form of linear fluorescent lamps from less than 1 foot to more than 8 feet in length and may typically be T4, T5, T8, T9, T10, T12, etc. Such embodiments of the present invention may use an insulating housing made from, for example but not limited to, glass or an appropriate type of plastic, which may or may not have a diffuser or be a diffuser in terms of the plastic. In some embodiments of the present invention plastic housings may be used that can include diffusers on the entire surface, diffusers on half the surface, diffusers on less than half the surface, diffusers on more than half of the surface, with the rest of the surface either being clear plastic, opaque plastic or a metal such as aluminum or an aluminum alloy.

Photon/wavelength conversion including down conversion can be used with the present invention including being able to adjust the photon/wavelength conversion electrically. Spectral/spectrum sensors can be used to detect the light spectral content and adjust the light spectrum by turning on or off certain wavelengths/colors of SSL. The spectral sensors could consist of color/wavelength sensitive detectors covering a range of colors/wavelengths of filters that only each only permit a certain, typically relatively narrow, range of wavelengths to be detected. As an example, red, orange, amber, yellow, green, blue, etc. color detectors could be included as part of the spectral/spectrum sensor or sensors. In some embodiments of the present invention, quantum dots can be used as part of and to implement the spectral/spectrum sensors.

Implementations of the present invention can include and consist of any number and arrangement of smart dimmers (by wired, wireless, powerline communications, etc. combinations of these, etc.) including ones that connect directly to the AC power lines that can control, but are not limited to, one or more of, for example, but not limited to, as an example, FLRs, A-lamps, PAR 30, PAR 38, PLC lamps, R20, R30, dimmable compact florescent lamps, incandescent bulbs, halogen bulbs, etc. as well as smart dimmable (i.e., by wired, wireless, powerline communications, etc., combinations of these, etc.), infrared controlled devices including heaters of any type or form, air conditioners of any type or form, color-changing, color-tunable, white color-changing, lighting of any type including but not limited to those discussed herein. Non-dimmable lamps and appliances and entertainment device can also be included in such implementations of the present invention and may be turned on and off by one or more of the smart on/off switches or a dimmer that is, for example, but not limited to, programmed to full on and full off only, etc. Such implementations of the present invention can also use one or more or all of the sensors, detectors, processes, approaches, etc. discussed herein and well as any other type or types of sensors, detectors, controls, etc. The smart lighting, dimmers, power supplies, sensors, controls, etc. can you any type or types of wired, wireless, and/or powerline communications. Any practical number of dimmers, lights, lighting, sensors, detectors, controls, monitoring, logging, analytics, heaters, air conditioners, fire, safety, burglar alarm(s), burglar protection, etc., appliances, entertainment devices, home safety, personal safety, thermometer(s), thermostat(s), humidifier(s), etc.

The present invention may use any type of circuit, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to provide a switched signal such as a PWM drive signal to the switching devices. In addition, additional voltage and/or current detect circuits may be used in place of or to augment the control and feedback circuits.

Some embodiments of the present invention can also accept the output of a fluorescent ballast replacement that is designed and intended for a LED Fluorescent Lamp Replacement that is remote dimmable and can also be Triac, Triac-based, forward and reverse dimmer dimmable and incorporates all of the discussion above for the example embodiments. The remote fluorescent lamp replacement ballast can use or receive control signals/commands from, for example, but not limited to any or all of wired, wireless, optical, acoustic, voice, voice recognition, motion, light, sonar, gesturing, sound, ultrasound, ultrasonic, mechanical, vibrational, and/or PLC, etc., combinations of these, etc. remote control, monitoring and dimming, motion detection/proximity detection/gesture detection, etc. In some embodiments, dimming or/other control can be performed using methods/techniques/approaches/algorithms/etc. that implement one or more of the following: motion detection, recognizing motion or proximity to a detector or sensor and setting a dimming level or control response/level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. sonar, light, mechanical, vibration, detection and sensing, etc. Some embodiments may be dual or multiple dimming and/or control, supporting the use of multiple sources, methods, algorithms, interfaces, sensors, detectors, protocols, etc. to control and/or monitor including data logging, data mining and analytics. Some embodiments of the present invention may be multiple dimming or control (i.e., accept dimming information, input(s), control from two or more sources).

Remote interfaces include, but are not limited to, 0 to 10 V, 0 to 2 V, 0 to 1 V, 0 to 3 V, etc., RS 232, RS485, DMX, WiFi, Bluetooth, ZigBee, IEEE 802, two wire, three wire, SPI, I2C, PLC, and others discussed in this document, etc. In various embodiments, the control signals can be received and used by the remote fluorescent lamp replacement ballast or by the LED, OLED and/or QD fluorescent lamp replacement or both. Such a Remote Controlled Florescent Ballast Replacement can also support color LED Fluorescent Lamp Replacements including single and multi-color including RGB, White plus red-green-blue (RGB) LEDs or OLEDs or other lighting sources, RGB plus one or more colors, red yellow blue (RYB), other variants, etc. Color-changing/tuning can include more than one color including RGB, WRGB, RGBW, WRGBA where A stands for amber, etc. 5 color, 6 color, N color, etc. Color-changing/tuning can include, but is not limited to, white color-tuning including the color temperature tuning/adjustments/settings/etc., color correction temperature (CCT), color rendering index (CRI), etc. Color rendering, color monitoring, color feedback and control can be implemented using wired or wireless circuits, systems, interfaces, etc. that can be interactive using for example, but not limited to, smart phones, tablets, computers, laptops, servers, remote controls, etc. The present invention can use or, for example, make, create, produces, etc. any color of white including but not limited to soft, warm, bright, daylight, cool, etc. Color temperature monitoring, feedback, and adjustment can be performed in such embodiments of the present invention. The ability to change to different colors when using light sources capable of supporting such (i.e., LEDs, OLEDs and/or QDs including but not limited to red, green, blue, amber, white LEDs and/or any other possible combination of LEDs and colors). Embodiments of the present invention has the ability to store color choices, selections, etc. and retrieve, restore, display, update, etc. these color choices and selections when using non-fluorescent light sources that can support color changing. Embodiments of the present invention also have the ability to change between various color choices, selections, and associated inputs to do as well as the ability to modulate the color choices and selections.

A further feature and capability of embodiments of present invention is use of passive or active clear, diffused, color filters and diffusers to produce enhanced lighting effects.

In addition, protection can be enabled (or disabled) by microcontroller(s), microprocessor(s), FPGAs, CLDs, PLDs, digital logic, etc. including remotely via wireless or wired connections, based on but not limited to, for example, a sequence of events and/or fault or no-fault conditions, sensor, monitoring, detection, safe operation, etc. An example of protection detection/sensing can include measuring/detecting/sensing lower current than expected due to, for example, a human person being in series with (e.g., in between) one leg of the LED, OLED and/or QD replacement fluorescent lamp and one side of the power being provided by the energized ballast. The present invention can use microcontroller(s), microprocessor(s), FPGA(s), other firmware and/or software means, digital state functions, etc. to accomplish protection, control, monitoring, operation, etc.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

The present invention can work with programmable soft start ballasts including being able to also have a soft short at turn-on which then allows the input voltage to rise to its running and operational level can also be included in various implementations and embodiments of the present invention.

Some embodiments of the present invention utilize high frequency diodes including high frequency diode bridges and current to voltage conversion to transform the ballast output into a suitable form so as to be able to work with existing AC line input PFC-LED circuits and drivers. Some other embodiments of the present invention utilize high-frequency diodes to transform the AC output of the electronic ballast (or the low frequency AC output of a magnetic ballast into a direct current (DC) format that can be used directly or with further current or voltage regulation to power and driver LEDs for a fluorescent lamp replacement. Embodiments of the present invention can be used to convert the low frequency (i.e., typically 50 or 60 Hz) magnetic ballast AC output to an appropriate current or voltage to drive and power LEDs using either or both shunt or series regulation. Some other embodiments of the present invention combine one or more of these. In some embodiments of the present invention, one or more switches can be used to clamp the output compliance current and/or voltage of the ballast. Various implementations of the present invention can involve voltage or current forward converters and/or inverters, square-wave, sine-wave, resonant-wave, etc. that include, but are not limited to, push pull, half-bridge, full-bridge, square wave, sine wave, fly-back, resonant, synchronous, etc.

For the present invention, in general, any type of transistor or vacuum tube or other similarly functioning device can be used including, but not limited to, MOSFETs, JFETs, GANFETs, depletion or enhancement FETs, N and/or P FETs, CMOS, PNP BJTs, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

The example figure and embodiments shown in herein are merely intended to provide some illustrations of the present inventions and not limiting in any way or form for the present inventions.

Using digital and/or analog designs and/or microcontrollers and/or microprocessors any and all practical combinations of control, protection, sequencing, levels, etc., some examples of which are listed below for the present invention, can be realized.

In addition to these examples, a potentiometer or similar device such as a variable resistor may be used to control the dimming level. Such a potentiometer may be connected across a voltage such that the wiper of the potentiometer can swing from minimum voltage (i.e., full dimming) to maximum voltage (i.e., full light). Often the minimum voltage will be zero volts which may correspond to full off and, for some embodiments of the present invention, the maximum will be equal to or approximately equal to the voltage on the negative input of, for example, a comparator.

Current sense methods including resistors, current transformers, current coils and windings, etc. can be used to measure and monitor the current of the present invention and provide both monitoring and protection.

In addition to dimming by adjusting, for example, a potentiometer, the present invention can also support all standards, ways, methods, approaches, techniques, etc. for interfacing, interacting with and supporting, for example, 0 to 10 V dimming with a suitable reference voltage that can be remotely set or set via an analog or digital input such as illustrated in patent application 61/652,033 filed on May 25, 2012, for a “Dimmable LED Driver”, which is incorporated herein by reference for all purposes.

The present invention supports all standards and conventions for 0 to 10 V dimming or other dimming techniques. In addition the present invention can support, for example, overcurrent, overvoltage, short circuit, and over-temperature protection. The present invention can also measure and monitor electrical parameters including, but not limited to, input current, input voltage, power factor, apparent power, real power, inrush current, harmonic distortion, total harmonic distortion, power consumed, watthours (WH) or kilowatt hours (kWH), etc. of the load or loads connected to the present invention. In addition, in certain configurations and embodiments, some or all of the output electrical parameters may also be monitored and/or controlled directly for, for example, LED drivers and FL ballasts. Such output parameters can include, but are not limited to, output current, output voltage, output power, duty cycle, PWM, dimming level(s), provide data monitoring, data logging, analytics, analysis, etc. including, but not limited to, input and output current, voltage, power, phase angle, real power, light output (lumens, lux), dimming level if appropriate, kilowatt hours (kWH), efficiency, temperature including temperatures of components, driver, LED or OLED array or array or strings or other types of configurations and groupings, etc.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The above examples and figures are merely meant to provide illustrations of the present and should not be construed as limiting in any way or form for the present invention.

In addition to the examples above and any combinations of the above examples, the present invention can have multiple dimming levels set by the dimmer in conjunction with the motion sensor and photosensor/photodetector and/or other control and monitoring inputs including, but not limited to, analog (e.g., 0 to 10 V, 0 to 3 V, etc.), digital (RS232, RS485, USB, DMX, SPI, SPC, UART, DALI, other serial interfaces, etc.), a combination of analog and digital, analog-to-digital converters and interfaces, digital-to-analog converters and interfaces, wired, wireless (i.e., RF, WiFi, ZigBee, Zwave, ISM bands, 2.4 GHz, Bluetooth, etc.), powerline (PLC) including X-10, Insteon, HomePlug, etc.), etc.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, wired, wireless, PLC interfaces, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, cuk, SEPIC, flyback and forward-converters including but not limited to push-pull, single and double forward converters, current mode, voltage mode, current fed, voltage fed, etc. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc. It should be noted that the various blocks shown in the drawings and discussed herein may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load. In addition to capacitors, inductors and resistors may also be used in some embodiments of the present invention.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one of the implementation of the present invention can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, be based on preferences, priorities, privileges, levels, decisions, permissions, etc., combinations of these, etc. and can employ smart and intelligent dimming decisions, artificial intelligence, remote control, remote dimming, etc.

The present invention involves comprehensive, simple to use, yet highly sophisticated, extremely energy-efficient, self-commissioning lighting control systems that easily allow and accommodate variations in interior artificial SSL system lighting that, for example, provide the proper light intensity and wavelength(s) of light to support effective and healthy environments including but not limited to circadian cycle regulation, treatment of seasonal affective disorder (SAD) and other time of day, intent of use, seasonal adjustments, etc. in lighting quality as examples of how the use of novel integration of digital controls including but not limited to daylight sensing, visible spectrum sensing, motion and occupancy/vacancy sensing/detection with color temperature tuning and specialized SSL can further conserve lighting energy. In addition, by incorporating internet of things (IOT) and related communication capabilities, a vast array of other sensors, transducers, functions, operations, features, etc. that can also include detection, security, safety, surveillance which can be designed into the digitally controlled and monitored SSL lights, lamps, luminaires, systems, etc. including both LED and OLED as well as combinations of these SSL can be realized. Highly cyber-secure encryption techniques can also be used. These advanced controls, IOT and digital features and functions not presently available with traditional sources.

Embodiments of the present invention implement SSL systems that are specifically designed for example but not limited to meeting all safety, enclosure, corrosion, ingress protection (IP) ratings (i.e., 66 to 68), that could use lighting sources including but not limited to solid state lighting including but not limited to LEDs and OLEDs, that can be powered by both conventional or alternate sources including renewable energy sources such as solar cells, wind, photovoltaic, thermal, geothermal, and/or wave as well as other sources, including power sources, etc., combinations of these, etc., that incorporate advanced, low cost and sophistications sensors and controls including but not limited to motion, RF identification, daylighting-day/night sensors and detectors which provide straightforward, easy-to-use self-commissioning lighting controls that conserve energy to a greater extent than can be provided by SSL or other lighting sources alone and also perform additional functions including but not limited to security, surveillance, emergency communications and alert and can be remotely controlled, monitored, logged, analyzed, etc. data mined, etc. including by using the cloud, web, mobile digital communications, etc.

The present invention may be used in conjunction with dimming to provide thermal control or other types of control to, for example, a dimming LED driver. For example, embodiments of the present invention or variations thereof may also be adapted to provide overvoltage or overcurrent protection, short circuit protection for, for example, a dimming LED or OLED driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless including as discussed above, powerline, etc. and can be implemented in any part of the circuit for the present invention. The present invention can be used with a buck, a buck-boost, a boost-buck and/or a boost, flyback, or forward-converter design, topology, implementation, others discussed herein, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

Some embodiments include a circuit that dynamically adjusts such that the output current to a load such as a LED and/or OLED array is essentially kept constant by, for example, in some embodiments of the present invention shorting or shunting current from the ballast as needed to maintain the output current to a load such as a LED array essentially constant. Some embodiments of the present invention may use time constants to as part of the circuit.

Some embodiments include a circuit to power a protection device/switch such that the switch is on unless commanded or controlled to be set off in the event/situation/condition of a fault hazard. Such a control can be implemented in various and diverse forms and types including, but not limited to, latching, hiccup mode, etc. In some embodiments of the present invention such a circuit may have a separate rectification stage. In and for various embodiments of the present invention, the device/switch may be of any type or form or function and includes but is not limited to, semiconductor switches, vacuum tube switches, mechanical switches, relays, etc.

Some embodiments include an over-voltage protection (OVP) circuit that shunts/shorts or limits the ballast output and/or the output to the load such as but not limited to a LED array or more than one LED array, an OLED, both LEDs and OLEDs, etc. in the event that the output voltage exceeds a set value.

Some embodiments include an over temperature protection (OTP) circuit that shunts/shorts or limits the ballast output and/or the output to the load such as a LED array or others discussed herein in the event that the temperature at one or more locations exceeds a set value or set values.

Embodiments of the present invention may also include short circuit protection (SCP) and other forms of protection including protection against damage due to other sources of power including but not limited to AC mains power lines and/or other types of devices, circuits, etc.

Some embodiments of the present invention may use, for example, but are not limited to capacitors to limit the low frequency (examples include, but are not limited to, AC line mains at 50 Hz, 60 Hz, 400 Hz) voltage and/or current that can be applied to the load.

Embodiments of the present invention include, but are not limited to, having a rectification stage (such as, but not limited to) consisting of a single full wave rectification stage to provide power/current to the output load such as an LED output load and a rectification stage (such as, but not limited to) consisting of a single full wave rectification stage to provide power to, for example, the hazard protection circuit.

Remote dimming can be performed using a controller implementing motion detection, recognizing motion or proximity to a detector or sensor and setting a dimming level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. Some embodiments may be dual dimming, supporting the use of a 0-10 V dimming signal in addition to a Triac-based or other phase-cut or phase angle dimmer. Some embodiments of the present invention may multiple dimming (i.e., accept dimming information, input(s), control from two or more sources). In addition, the resulting dimming, including current or voltage dimming, can be either PWM (digital) or analog dimming or both or selectable either manually, automatically, or by other methods and ways including software, remote control of any type including, but not limited to, wired, wireless, voice, voice recognition, gesturing including hand and/or arm gesturing, pattern and motion recognition, PLC, RS232, RS422, RS485, SPI, I2C, universal serial bus (USB), Firewire 1394, DALI, DMX, etc. Voice, voice recognition, gesturing, motion, motion recognition, etc. can also be transmitted via wireless, wired and/or powerline communications or other methods, etc. In some embodiments of the present invention speakers, earphones, microphones, etc. may be used with voice, voice recognition, sound, etc. and other methods, ways, approaches, algorithms, etc. discussed herein.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

Embodiments of the present invention may include motion and light/photodetection control, can and may also use other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (FETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

The examples shown above are intended to provide non-limiting examples of the present invention and represent only a very small sampling of the possible ways, topologies, connections, arrangements, applications, etc. of the present invention. Based upon the disclosure provided herein, one of skill of the art will recognize a number of combinations and applications of solid state lighting system elements disclosed herein that can be used in accordance with various embodiments of the invention without departing from the inventive concepts.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system, block or circuit may be implemented in software or firmware, while other parts are implemented in hardware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components. For example, op amp and comparator in most cases may be used in place of one another in this document.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

The examples shown above are intended to provide non-limiting examples of the present invention and represent only a very small sampling of the possible ways, topologies, connections, arrangements, applications, etc. of the present invention. Based upon the disclosure provided herein, one of skill of the art will recognize a number of combinations and applications of solid-state and other lighting system elements disclosed herein that can be used in accordance with various embodiments of the invention without departing from the inventive concepts.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system, block or circuit may be implemented in software or firmware, while other parts are implemented in hardware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An apparatus for supplying power comprising:
a power input;
a switch connected to the power input;
a load configured to draw power from the power input through the switch; and
a switch lock configured to prevent the switch from disconnecting the load from the power input.

2. The apparatus of claim 1, wherein the switch lock comprises a cover configured to prevent the switch from being accessible by a user.

3. The apparatus of claim 1, wherein the switch lock is configured to physically prevent the switch from being turned off.

4. The apparatus of claim 3, wherein the switch lock is configured to allow the switch to be dimmed without being fully turned off.

5. The apparatus of claim 1, the switch lock comprising an adhesive mount configured to adhere to a cover plate over the switch.

6. The apparatus of claim 1, the switch lock being configured to connect to the switch by at least one screw.

7. The apparatus of claim 1, the switch lock being configured to connect to the switch in place of a cover plate.

8. The apparatus of claim 1, the switch lock comprising a user interface.

9. The apparatus of claim 8, wherein the user interface comprises at least one input and at least one display indicator.

10. The apparatus of claim 8, the switch lock further comprising a communications circuit configured to communicate with the load.

11. The apparatus of claim 10, wherein the communications circuit is configured to communicate settings from the user interface with the load.

12. The apparatus of claim 11, wherein the settings comprise dimming commands.

13. The apparatus of claim 11, wherein the settings comprise color settings.

14. The apparatus of claim 1, the load comprising a lighting system, the switch lock further comprising a control circuit configured to control the lighting system.

15. The apparatus of claim 14, the switch lock comprising a wireless communications circuit configured to transmit control information from the control circuit to control the lighting system.

16. The apparatus of claim 14, the control circuit being configured to control the lighting system based on information from a network connection.

17. The apparatus of claim 16, wherein the information from the network connection comprises sunlight data from an Internet source.

18. The apparatus of claim 16, wherein the information from the network comprises a therapeutic light program.

19. The apparatus of claim 1, the switch lock further comprising at least one sensor.

20. The apparatus of claim 19, wherein the at least one sensor comprises a light sensor.
